(19) United States
(12) Patent Application Publication
(10) Pub. No.: US 2021/0157871 A1
(43) Pub. Date: May 27, 2021

(54) ELECTRONIC DEVICE FOR PROVIDING RESPONSE TO USER QUERY AND OPERATING METHOD THEREOF

(71) Applicant: LG ELECTRONICS INC., Seoul (KR)

(72) Inventors: Jongyeop Lee, Seoul (KR); Yonghwan Lee, Seoul (KR); Hoolim Kim, Seoul (KR); Kihyeon Kim, Seoul (KR)

(73) Assignee: LG ELECTRONICS INC., Seoul (KR)

(21) Appl. No.: 17/083,234

(22) Filed: Oct. 28, 2020

(30) Foreign Application Priority Data
Nov. 26, 2019 (KR) 10-2019-0153338

(51) Int. Cl. G06F 16/9535; G06F 16/9538; G06F 16/9537; G06F 16/904

(52) U.S. Cl. CPC G06F 16/9535; G06F 16/904; G06F 16/9537; G06F 16/9538

(57) ABSTRACT

Various embodiments of the present disclosure relate generally to an electronic device for providing a response to a user query and an operating method therefor. The electronic device includes an input unit, an output unit, a memory, and at least one processor, wherein the at least one processor receives query-related information from a server over a network, stores the received query-related information in the memory; detects user query through the input unit, determines whether the user query is a query for requesting a response using the network. At least one of an autonomous vehicle (autonomous vehicle), a user terminal, and a server of the present disclosure may be associated with an artificial intelligence module, an unmanned aerial vehicle (UAV), a robot, an augmented reality (AR) device, a virtual reality (VR) device, a device related to 5G service, and the like.

### CROSS REFERENCE TO RELATED APPLICATIONS

Pursuant to 35 U.S.C. § 119(a), this application claims the benefit of earlier filing date and right of priority to Korean Patent Application No. 10-2019-0153338, filed on Nov. 26, 2019, the contents of which are all hereby incorporated by reference herein in their entirety.

### BACKGROUND OF THE INVENTION

### Field of the Invention

Various embodiments of the present disclosure relate to an electronic device for providing a response to a user query and an operating method thereof.

### Description of the Related Art

Due to the development of digital technology, electronic devices of various types, such as TV (television), mobile communication terminal, personal digital assistant (PDA), electronic notebook, smart phone, tablet PC (wearable device), wearable device, autonomous vehicle device, and the like are being used.

The electronic device may provide an artificial intelligence service based on a voice recognition technology. For example, the electronic device may recognize a user query from a voice signal spoken by the user on the basis of a voice recognition technology, and provide a response corresponding to the recognized user query.

### SUMMARY OF THE INVENTION

The electronic device may access a network and then provide a response according to a user query, or may provide a response by using at least one component included in the electronic device without accessing a network. A method of accessing a network and then providing a response in an electronic device has problems that the response time is longer compared to a method of providing a response without accessing a network, and a response cannot be provided when a network connection is impossible due to a communication environment.

Accordingly, various embodiments of the present disclosure disclose an electronic device that provides a response to a user query in the electronic device and an operating method therefor.

The technical problem to be achieved in this document is not limited to the technical problem mentioned above, and other technical problems not mentioned above will be clearly understood by those skilled in the art to which the present disclosure pertains.

According to various embodiments of the present disclosure, an electronic device includes an input unit, an output unit, a memory, and at least one processor, wherein the at least one processor receives query-related information from a server over a network, stores the received query-related information in the memory, detects a user query through the input unit, determines whether the user query is a query for requesting a response using the network, determines a response to the user query on the basis of the query-related information stored in the memory, when the user query is the query for requesting the response using the network, and performs control so that the determined response is output through the output unit, wherein the query-related information includes at least one of at least one query, at least one response corresponding to the at least one query, or at least one additional information corresponding to the at least one query.

According to various embodiments of the present disclosure, a server includes a communication transceiver, a memory, and a processor, wherein the processor receives feedback information including at least one query from an electronic device through the communication transceiver to store the feedback information in the memory, generates query-related information to be provided to the electronic device on the basis of the information stored in the memory, and controls the communication transceiver so that the generated query-related information is transmitted to the electronic device, and the query-related information includes at least one of at least one query, at least one response corresponding to the at least one query, or at least one additional information corresponding to the at least one query.

According to various embodiments of the present disclosure, a method of providing a response to an electronic device includes: receiving query-related information from a server via a communication transceiver; caching the received query-related information; detecting a user query through an input unit; determining whether the user query is a query for requesting a response using a network; determining a response to the user query on the basis of the cached query-related information when the user query is the query for requesting a response using the network; and outputting the determined response through an output unit, wherein the query-related information includes at least one of at least one query, at least one response corresponding to the at least one query, or at least one additional information corresponding to the at least one query.

### BRIEF DESCRIPTION OF THE DRAWINGS

The above and other objects, features, and other advantages of the present invention will be more clearly understood from the following detailed description when taken in conjunction with the accompanying drawings, in which:

FIG. 1 is a view illustrating an example of a basic operation of an autonomous vehicle and a 5G network in a 5G communication system.

FIG. 2 shows a view illustrating an example of an application operation of an autonomous vehicle and a 5G network in a 5G communication system.

FIGS. 3 to 6 are views illustrating an example of an operation of an autonomous vehicle using a 5G communication.

FIG. 7 is a block diagram illustrating an electronic device according to various embodiments of the present disclosure.

FIG. 8 is a block diagram illustrating a server according to various embodiments of the present disclosure;

FIG. 9 is a conceptual block diagram illustrating a system for providing a response to a user query according to various embodiments of the present disclosure;

FIG. 10 is a flowchart illustrating providing a response to a user query in an electronic device according to various embodiments of the present disclosure;

FIG. 11 is a flowchart illustrating caching query-related information in an electronic device according to various embodiments of the present disclosure;

FIGS. 12A and 12B are exemplary diagrams illustrating caching query-related information in an electronic device according to various embodiments of the present disclosure;

FIG. 13 is a flowchart illustrating caching a prediction query and a response in an electronic device according to various embodiments of the present disclosure;

FIGS. 14A and 14B are exemplary diagrams illustrating caching a prediction query and response in an electronic device according to various embodiments of the present disclosure;

FIG. 15 is a flowchart illustrating providing a response to a user query requesting a response using a network in an electronic device according to various embodiments of the present disclosure;

FIG. 16 is a flowchart illustrating providing query-related information in a server according to various embodiments of the present disclosure; and

FIG. 17 is a flowchart illustrating query-related information learned in a server according to various embodiments of the present disclosure.

### DETAILED DESCRIPTION OF THE INVENTION

Advantages and features of the present disclosure, and methods of achieving the same will become apparent with reference to the embodiments described below in detail in conjunction with the accompanying drawings. However, the present disclosure is not limited to the embodiments disclosed below, but may be implemented in various different forms. The present embodiments are intended to complete the disclosure of the present disclosure and provided to fully inform the skilled in the art to which the disclosure pertains of the scope of the disclosure. The disclosure is defined only by the scope of the claims. Like reference numerals refer to like elements throughout.

When one component is referred to as being “connected to” or “coupled to” another component, the component may be directly connected or coupled to the other component or may be connected or coupled to the other component with a further component in between. Meanwhile, when one component is referred to as “directly connected to” or “directly coupled to” the other component indicates that no another component is interposed. “And/or” includes each of the items and one or more combinations thereof.

The terminology used herein is for the purpose of describing particular embodiments only and is not intended to limit the present disclosure. In this specification, the singular also includes the plural unless specifically stated otherwise in the phrase. As used herein, “comprises” and/or “comprising” does not exclude existence or addition of one or more other components, steps, operations, and/or elements.

Although the first, the second, and the like are used to describe various components, these components are of course not limited by these terms. These terms are only used to distinguish one component from another.

Therefore, of course, the first component mentioned below may be the second component within the technical spirit of the present disclosure. Unless otherwise defined, all terms (including technical and scientific terms) used in the present specification may be used in a sense that can be commonly understood by those skilled in the art to which the present disclosure belongs. In addition, the terms defined in the commonly used dictionaries are not ideally or excessively interpreted unless they are specifically defined clearly.

Terms “module” or “unit” used in the following description means a hardware component such as software or a field programmable gate array (FPGA) or an application specific integrated circuit (ASIC), and the “unit” or “module” performs certain roles. However, “unit” or “module” is not limited to software or hardware. The “unit” or “module” may be configured to be located in an addressable storage medium or may be configured to regenerate one or more processors. Thus, as an example, the “unit” or “module” may include components such as software components, object-oriented software components, class components, and task components, processes, functions, properties, procedures, subroutines, segments of program code, drivers, firmware, microcode, circuitry, data, databases, data structures, tables, arrays, and variables. Functions provided within components and “unit” or “modules” may be separated into smaller numbers of components and “units” or “modules” or integrated into additional components and “unit” or “modules”.

The steps of a method or algorithm described in connection with some embodiments of the present invention may be embodied directly in hardware module, software module, or a combination thereof, executed by a processor. The software module may reside in RAM memory, flash memory, ROM memory, EPROM memory, EEPROM memory, registers, hard disk, removable disk, CD-ROM, or any other type of recording medium known in the art. An exemplary recording medium is coupled to the processor, which can read information from and write information to the storage medium. In the alternative, the recording medium may be integral to the processor. The processor and the recording medium may reside in an application specific integrated circuit (ASIC). The ASIC may reside in a user terminal.

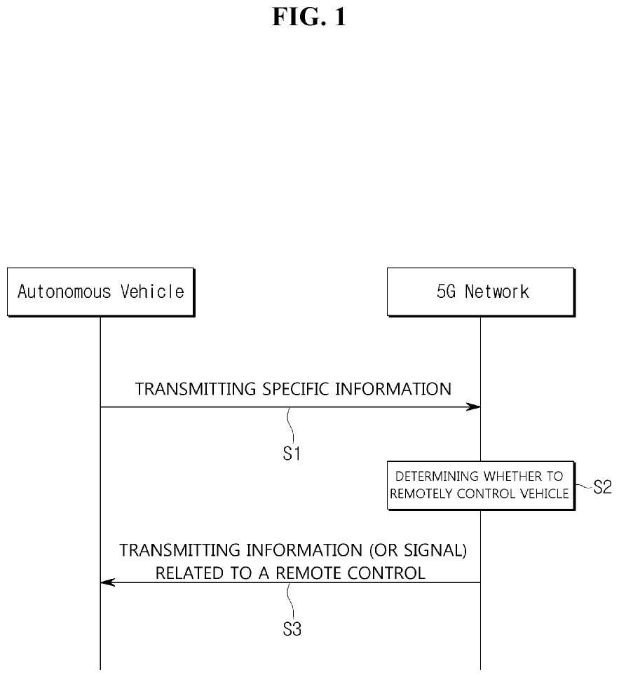

FIG. 1 is a view illustrating an example of a basic operation of an autonomous vehicle and a 5G network in a 5G communication system.

The autonomous vehicle transmits specific information to a 5G network (S1).

The specific information may include autonomous driving-related information.

The autonomous driving-related information may be information directly related to driving control of the vehicle. For example, the autonomous driving-related information may include one or more of pieces of object data indicating the object around the vehicle, map data, vehicle state data, vehicle location data, and driving plan data.

The autonomous driving-related information may further include service information that is necessary for autonomous driving. For example, the specific information may include information related to a destination input through a user terminal and a stability level of the vehicle.

The 5G network may determine whether to remotely control the vehicle (S2).

Here, the 5G network may include a server or a module that performs autonomous driving-related remote control.

The 5G network may transmit information (or a signal) related to a remote control to the autonomous vehicle (S3).

As described above, the information related to the remote control may be a signal applied directly to the autonomous vehicle, and may further include service information required for autonomous driving. According to an embodiment of the present disclosure, the autonomous vehicle receives service information, such as insurance information for each section selected on a driving route and danger section information, through a server connected to the 5G network, thereby providing service related to autonomous driving.

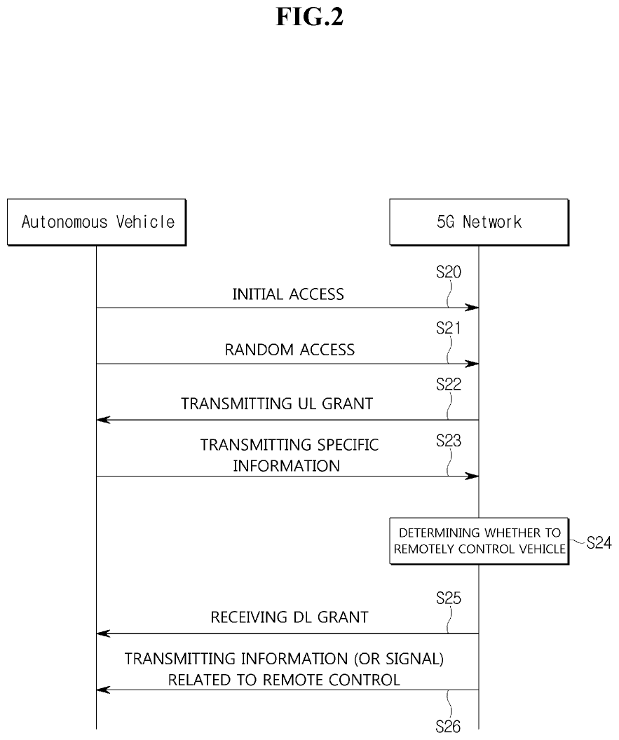

Hereinafter, referring to FIGS. 2 to 6, according to an embodiment of the present disclosure, an essential process (e.g., an initial access procedure between vehicle and 5G network) for 5G communication between an autonomous vehicle and a 5G network will be generally described, in order to provide insurance services applicable for each section in an autonomous driving process.

FIG. 2 is a view illustrating an example of an application operation of an autonomous vehicle and a 5G network in a 5G communication system.

The autonomous vehicle performs an initial access procedure with a 5G network (S20).

The initial access procedure may include a cell search for acquiring a downlink (DL) operation, a process of acquiring system information, and the like.

In addition, the autonomous vehicle performs a random access procedure with the 5G network (S21).

The random access procedure includes a preamble transmission, a random access response reception process, and the like for uplink (UL) synchronization acquisition or UL data transmission.

In addition, the 5G network transmits an UL grant for scheduling transmission of specific information to the autonomous vehicle (S22).

The UL Grant reception includes receiving time/frequency resource scheduling for transmission of UL data to the 5G network.

In addition, the autonomous vehicle 10 transmits specific information to the 5G network on the basis of the UL grant (S23).

In addition, the 5G network determines whether to remotely control the vehicle (S24).

In addition, the autonomous vehicle receives a DL grant through a physical downlink control channel in order to receive a response to the specific information from the 5G network (S25).

The 5G network transmits information (or a signal) related to remote control to the autonomous vehicle on the basis of the DL grant (S26).

Meanwhile, in FIG. 2, an example in which the initial access procedure and/or the random access process and the downlink grant reception process between the autonomous vehicle and the 5G network are combined are exemplarily described through steps S20 to S26, but the present disclosure is not limited thereto.

For example, the initial access process and/or the random access process may be performed through steps S20, S22, S23, S24, and S26. Also, for example, the initial access procedure and/or the random access procedure may be performed through steps S21, S22, S23, S24, and S26. In addition, the process in which an AI operation and the downlink grant reception process are combined may be performed through steps S23, S24, S25, and S26.

In addition, in FIG. 2, the operation of the autonomous vehicle is exemplarily described through steps S20 to S26, and the present disclosure is not limited thereto.

For example, the autonomous vehicle may be operated by allowing steps S20, S21, S22, and S25 to be selectively combined with steps S23 and S26. Also, for example, the operation of the autonomous vehicle may be configured with steps S21, S22, S23, and S26. Also, for example, the operation of the autonomous vehicle may be configured with steps S20, S21, S23, and S26. Also, for example, the operation of the autonomous vehicle may be configured with steps S22, S23, S25, and S26.

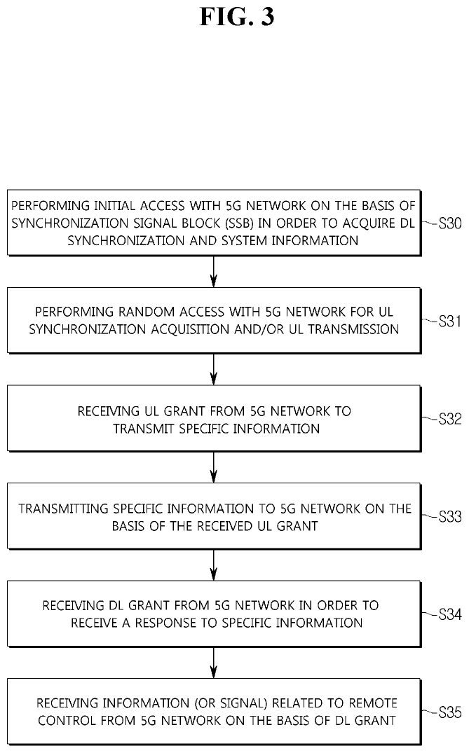

FIGS. 3 to 6 are views illustrating an example of an operation of an autonomous vehicle using a 5G communication.

First, referring to FIG. 3, the autonomous vehicle including the autonomous driving module performs an initial access procedure with a 5G network on the basis of a synchronization signal block (SSB) in order to acquire DL synchronization and system information (S30).

In addition, the autonomous vehicle performs a random access procedure with a 5G network for UL synchronization acquisition and/or UL transmission (S31).

In addition, the autonomous vehicle receives a UL grant from the 5G network to transmit specific information (S32).

In addition, the autonomous vehicle transmits specific information to the 5G network on the basis of the UL grant (S33).

In addition, the autonomous vehicle receives the DL grant from the 5G network in order to receive a response to specific information (S34).

In addition, the autonomous vehicle receives information (or a signal) related to remote control from the 5G network on the basis of the DL grant (S35).

A beam management (BM) process may be added to S30; a beam failure recovery process related to physical random access channel (PRACH) transmission may be added to S31; a QCL relationship addition process related to a beam reception direction of PDCCH including a UL grant may be added to S32, and a QCL relationship addition process related to a beam transmission direction of a physical uplink control channel (PUCCH)/physical uplink shared channel (PUSCH) including specific information may be added to step S33. In addition, a QCL relationship addition process related to a beam reception direction of a PDCCH including a DL grant may be added to step S34.

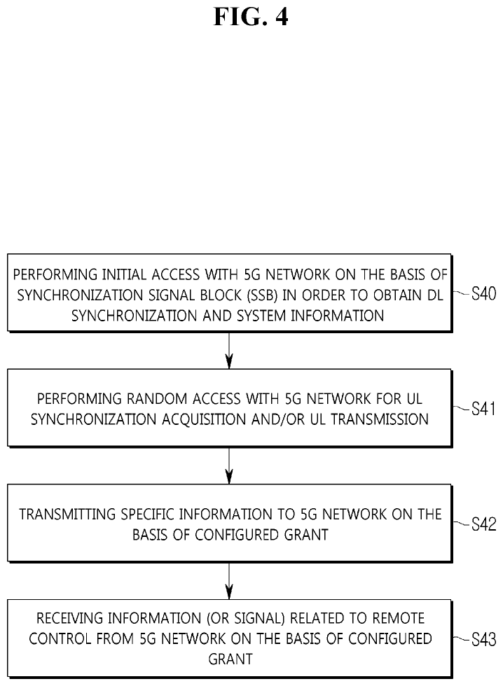

Referring to FIG. 4, the autonomous vehicle performs an initial access procedure with a 5G network on the basis of SSB in order to obtain DL synchronization and system information (S40).

In addition, the autonomous vehicle performs a random access procedure with the 5G network for UL synchronization acquisition and/or UL transmission (S41).

In addition, the autonomous vehicle transmits specific information to the 5G network on the basis of the configured grant (S42). Instead of performing the UL grant from the 5G network, a process of using the configured grant will be specifically described in the following paragraph.

In addition, the autonomous vehicle receives information (or a signal) related to the remote control from the 5G network on the basis of the configured grant (S43).

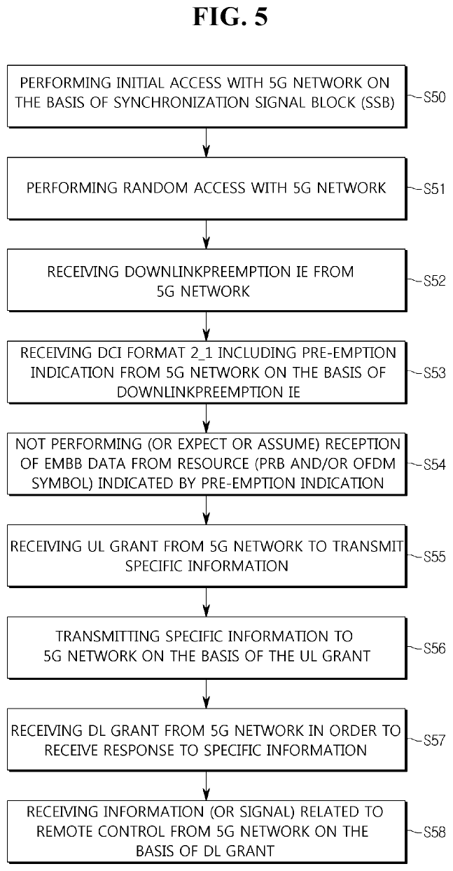

Referring to FIG. 5, the autonomous vehicle performs an initial access procedure with a 5G network on the basis of the SSB in order to acquire DL synchronization and system information (S50).

In addition, the autonomous vehicle performs a random access procedure with the 5G network for UL synchronization acquisition and/or UL transmission (S51).

In addition, the autonomous vehicle 10 receives a DownlinkPreemption IE from the 5G network (S52).

In addition, the autonomous vehicle receives a DCI format 2_1 including a pre-emption indication from the 5G network on the basis of the DownlinkPreemption IE (S53).

In addition, the autonomous vehicle does not perform (or expect or assume) reception of eMBB data from a resource (PRB and/or OFDM symbol) indicated by a pre-emption indication (S54).

In addition, the autonomous vehicle receives the UL grant from the 5G network to transmit specific information (S55).

The autonomous vehicle transmits specific information to the 5G network on the basis of the UL grant (S56).

In addition, the autonomous vehicle receives the DL grant from the 5G network in order to receive a response to specific information (S57).

In addition, the autonomous vehicle receives information (or a signal) related to remote control from the 5G network on the basis of the DL grant (S58).

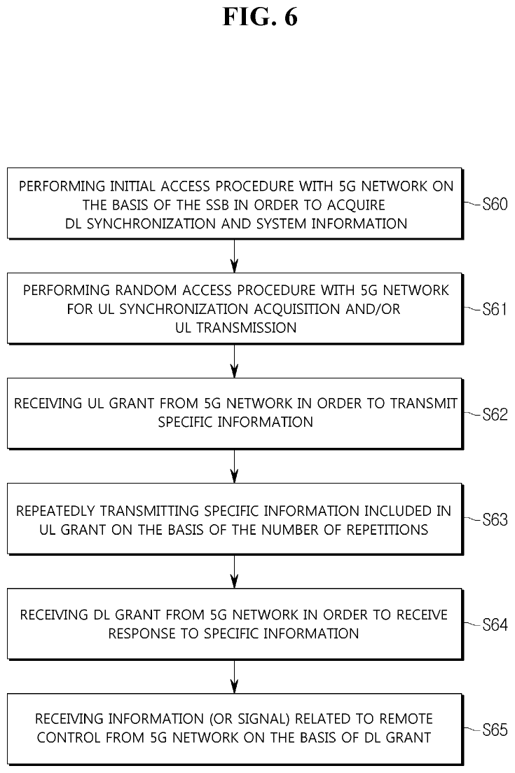

Referring to FIG. 6, the autonomous vehicle performs an initial access procedure with a 5G network on the basis of the SSB in order to acquire DL synchronization and system information (S60).

In addition, the autonomous vehicle performs a random access procedure with the 5G network for UL synchronization acquisition and/or UL transmission (S61).

In addition, the autonomous vehicle receives the UL grant from the 5G network in order to transmit specific information (S62).

The UL grant includes information on the number of repetitions for transmission of the specific information, and the specific information is repeatedly transmitted on the basis of the information on the number of repetitions (S63).

In addition, the autonomous vehicle transmits specific information to the 5G network on the basis of the UL grant.

In addition, the repetitive transmission of the specific information may be performed through frequency hopping, transmission of first specific information may be transmitted in a first frequency resource, and transmission of second specific information may be transmitted in a second frequency resource.

The specific information may be transmitted through a narrowband of 6 RB (Resource Block) or 1 RB (Resource Block).

In addition, the autonomous vehicle receives a DL grant from the 5G network in order to receive a response to specific information (S64).

In addition, the autonomous vehicle receives information (or a signal) related to remote control from the 5G network on the basis of the DL grant (S65).

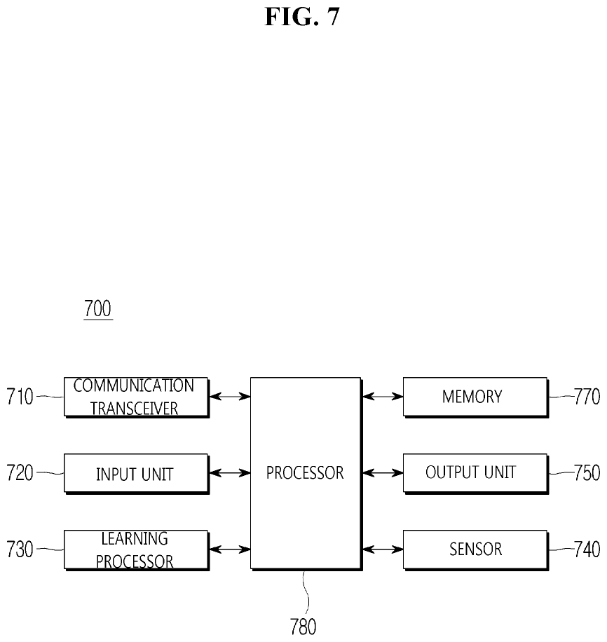

The 5G communication technology described above may be applied in combination with the embodiments that will be described referring to FIGS. 7 to 17, or may be supplemented to specify or clarify the technical features of the embodiments herein.

The vehicle described herein is connected to an external server via a communication network and is capable of moving along a preset route without driver intervention using autonomous driving technology. The vehicle of the present disclosure may be implemented as an internal combustion engine vehicle having an engine as a power source, a hybrid vehicle having an engine and an electric motor as a power source, an electric vehicle having an electric motor as a power source, and the like.

In the following embodiments, a user may be interpreted as a driver, a passenger, or an owner of a user terminal. The user terminal may be a mobile terminal, for example, a smart phone, which is capable of being carried by the user can carry and executing various applications such as a phone call, but the present disclosure is not limited thereto. For example, the user terminal may be interpreted as a mobile terminal, a personal computer (PC), a notebook computer, or an autonomous vehicle system.

In the autonomous vehicles, types and frequencies of accidents may vary greatly, depending on the ability to sense the risk elements around the vehicle in real time. Routes to the destination may include sections with different levels of risk due to various reasons, such as weather, terrain characteristics, and traffic congestion. The autonomous vehicle may show the insurance necessary for each section when the user enters the destination and update the insurance guide through real-time monitoring of the danger section.

At least one of the autonomous vehicle, the user terminal, or the server of the present disclosure may be associated or united with an artificial intelligence module, an unmanned aerial vehicle (UAV), a robot, an augmented reality (AR) device, a virtual reality (VR), 5G service related device, or the like.

For example, the autonomous vehicle may operate in association with at least one artificial intelligence module and robot included in the vehicle.

For example, the vehicle may interact with at least one robot. The robot may be an autonomous mobile robot (AMR) capable of moving by itself. Accordingly, the mobile robot may move freely, and may be provided with a plurality of sensors to avoid obstacles while driving, thereby driving while avoiding obstacles. The mobile robot may be a flying robot (e.g., a drone) having a flying device. The mobile robot may be a wheeled robot that has at least one wheel and moves through rotation of the wheel. The mobile robot may be a legged robot that has at least one leg and moves using the leg.

The robot may function as a device that complements the convenience of the vehicle user. For example, the robot may perform a function of delivering a load loaded on a vehicle to a user's final destination. For example, the robot may perform a function of guiding a route to a final destination to a user who gets off the vehicle. For example, the robot may perform a function of transporting a user who gets off the vehicle to the final destination.

At least one electronic device included in the vehicle may communicate with the robot through the communication device.

At least one electronic device included in the vehicle may provide data processed by the at least one electronic device included in the vehicle to the robot. For example, the at least one electronic device included in the vehicle may provide at least one of pieces of object data indicating an object around the vehicle, HD map data, vehicle state data, vehicle location data, and driving plan data, to the robot.

At least one electronic device included in the vehicle may receive data processed by the robot from the robot. The at least one electronic device included in the vehicle may receive at least one of pieces of sensing data generated by the robot, object data, robot state data, robot location data, and robot movement plan data.

At least one electronic device included in the vehicle may generate a control signal on the basis of data received from the robot. For example, the at least one electronic device included in the vehicle may compare information about the object generated in the object detecting apparatus with information about the object generated by the robot, and generate a control signal on the basis of the comparison result. At least one electronic device included in the vehicle may generate a control signal so that interference between the movement rout of the vehicle and the movement route of the robot does not occur.

At least one electronic device included in the vehicle may include a software module or a hardware module (hereinafter, referred to as an artificial intelligence module) that implements artificial intelligence (AI). The at least one electronic device included in the vehicle may input the obtained data into the artificial intelligence module and use the data output from the artificial intelligence module.

The artificial intelligence module may perform machine learning on input data using at least one artificial neural network (ANN). The artificial intelligence module may output driving plan data by performing machine learning on input data.

At least one electronic device included in the vehicle may generate a control signal on the basis of the data output from the artificial intelligence module.

According to an embodiment, at least one electronic device included in the vehicle may receive data processed by the artificial intelligence from an external device through a communication device. At least one electronic device included in the vehicle may generate a control signal on the basis of the data processed by artificial intelligence.

An artificial intelligence technology refers to the field of researching the artificial intelligence or methodology to create the same, and a machine learning technology refers to the field of researching methodology to define and solve various problems in the field of the artificial intelligence. The machine learning is defined as an algorithm that improves the performance of a task through a consistent experience for the task.

An artificial neural network (ANN), as a model used in machine learning, may refer to a general model having problem-solving capability and configured with artificial neurons (nodes) formed by synaptic connections. The artificial neural network may be defined by a connection pattern between neurons of different layers, a learning process of updating model parameters, and an activation function generating an output value.

The artificial neural network may include an input layer, an output layer, and optionally one or more hidden layers. Each layer contains one or more neurons, and the artificial neural network may contain synapses that connect neurons to neurons. In the artificial neural network, each neuron may output a function value of an active function for input signals, weights, and deflections input through the synapse.

The model parameter refers to a parameter determined through learning and includes weights of synaptic connections and deflection of neurons. In addition, the hyperparameter means a parameter to be set in the machine learning algorithm before learning, and includes a learning rate, the number of iterations, a mini batch size, and an initialization function.

The purpose of learning the artificial neural network may be considered as determining model parameters that minimize a loss function. The loss function may be used as an index for determining the optimal model parameters during training of artificial neural networks.

The machine learning may be categorized into supervised learning, unsupervised learning, and reinforcement learning depending on the learning method.

The supervised learning means how to train the artificial neural network, in a state that a label for the training data is given, in which the label may mean a correct answer (or result) that the artificial neural network must infer when the training data is entered into the artificial neural network. The unsupervised learning may mean a method of learning the artificial neural network, in a state that a label for the training data is not given. The reinforcement learning may mean a learning method that allows an agent defined in an environment to learn to choose an action or sequence of actions that maximizes cumulative reward in each state.

Machine learning, which is implemented as a deep neural network (DNN) that includes a plurality of hidden layers among artificial neural networks, is called deep learning, and the deep learning is a part of the machine learning. Hereinafter, the machine learning meaningfully includes the deep learning.

FIG. 7 is a block diagram illustrating an electronic device according to various embodiments of the present disclosure. The electronic device of FIG. 7 may be an electronic device included in the autonomous vehicle of FIG. 1 and/or FIG. 2. The electronic device 700 illustrated in FIG. 7 is configured according to an embodiment, and each component thereof may be formed with one chip, component, or electronic circuit, or may be configured with a combination of chips, components, or electronic circuits. According to another embodiment, some of the components shown in FIG. 1 may be separated into a plurality of components and may be configured with different chips or components or electronic circuits, and some components may be combined to form a single chip, component, or an electronic circuit. According to another embodiment, some of the components shown in FIG. 1 may be omitted, or other components not shown in FIG. 1 may be added.

Referring to FIG. 7, the electronic device 700 may include a communication transceiver 710, an input unit 720, a learning processor 730, a sensor 740, an output unit 750, a memory 770, and a processor 780.

According to various embodiments, the communication transceiver 710 may support wireless communication between the electronic device 700 and an external device (e.g., a server, and/or other electronic device). According to an embodiment, the communication transceiver 710 may include at least one of a broadcast receiving module, a mobile communication module, a wireless internet module, a short range communication module, and a location information module. The broadcast reception module may receive a broadcast signal and/or broadcast related information from an external broadcast management server through a broadcast channel. The mobile communication module may transmit and receive wireless signals with at least one of a base station, an external electronic device, and a server on a mobile communication network constructed according to technical standards or communication schemes (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), 5G communication, and the like. The listed communication schemes are exemplary only, and various embodiments of the present disclosure are not limited thereto. The wireless internet module may be embedded in or external to the electronic device 700, as a module for wireless internet access.

The wireless internet module may transmit and receive wireless signals for data communication in a communication network according to wireless internet technologies. Wireless Internet technologies include, for example, Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), and the like.

The short range communication module may support the short range communication using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (Wireless USB) technology.

The location information module is a module for obtaining a location (or current location) of the electronic device 700 and may include, for example, a Global Positioning System (GPS) module and/or a Wireless Fidelity (WiFi) module. When the location information module includes a GPS module, the location information module may acquire the location of the electronic device 700 using a signal received from a GPS satellite.

According to an embodiment, the communication transceiver 710 may include at least one communication module supporting a vehicle to everything (V2X) communication technology. For example, the communication transceiver 710 may support at least one communication technology of a vehicle to vehicle (V2V), a vehicle to infrastructure (V2I), a vehicle to nomadic device (V2N), or a vehicle to pedestrian (V2P). Alternatively, the communication transceiver 710 may include at least one communication module supporting a mobile communication technology. For example, the communication transceiver 710 may support at least one communication technology of 4G LGE, 5G, WiFi, and Bluetooth.

The input unit 720 receives an instruction or data to be used for the operation of at least one component (for example, the processor 780 and the learning processor 730) included in the electronic device 700 from the outside of the electronic device 700. The input unit 720 may include, for example, at least one of a camera for inputting an image signal, a microphone for receiving an audio signal, or a user input for receiving information from a user.

The camera may process image frames such as still images or moving images obtained by an image sensor in a video call mode or a photographing mode. The processed image frames may be displayed through a display included in the output unit 750 or stored in the memory 770.

The microphone may process external sound signals into electrical voice data. According to various embodiments, the microphone may receive a voice signal including a user query and convert the voice signal into electrical voice data. The processed voice data may be utilized in various ways according to a function (or a running application program) being performed by the electronic device 700. Meanwhile, various noise reduction algorithms may be implemented in the microphone to remove noise generated in the process of receiving an external sound signal.

The user input unit is a mechanical input means (or a mechanical key, for example, a button, a dome switch, a jog wheel, a jog switch, etc. located on one surface of the electronic device 700), and/or a touch input means. The touch input means is composed of a virtual key, a soft key, or a visual key displayed on the display of the electronic device 700 through software processing, or a touch key disposed on a portion other than the display. Meanwhile, the virtual key may be displayed, for example, as graphic, text, icon, video, or a combination thereof, on the touch screen while having various forms.

The learning processor 730 may be configured to receive, classify, store, and output information to be used in data mining, data analysis, intelligent decision making, and machine learning algorithms and/or techniques. The learning processor 730 may include one or more memory units configured to store data, which is received, detected, detected, generated, and predefined by the electronic device 700; output, received, detected, detected, generated, and predefined in other method; or output by another component, device, the electronic device 700, or an external device in communication with the electronic device 700 in other method.

The learning processor 730 may include a memory integrated with or implemented in the electronic device 700. In some embodiments, the learning processor 730 may be implemented using the memory 770.

Alternatively or additionally, the learning processor 730 may be implemented using a memory associated with the electronic device 700, such as external memory coupled directly to the electronic device 700, or memory maintained in a server communicating with the electronic device 700.

According to another embodiment, the learning processor 730 may be implemented using a memory maintained in a cloud computing environment, or other remote memory location accessible by the electronic device 700 via a communication scheme such as a network.

The learning processor 730 may be generally configured to store data in one or more database files, in order to identify, index, categorize, manipulate, store, retrieve, and output data for use in supervised or unsupervised learning, data mining, predictive analysis, or other machines.

The information stored in the learning processor 730 may be used by the processor 780 or one or more controllers of the electronic device using any of a variety of different types of data analysis algorithms and machine learning algorithms. Examples of such algorithms include k-near neighbor systems, fuzzy logic (e.g. probability theory), neural networks, Boltzmann machines, vector quantization, pulse neural networks, support vector machines, maximum margin classifiers, hill climbing, inductive logic systems Bayesian networks, Peretnets (e.g., finite state machines, Millie machines, Moore finite state machines), classifier tree (e.g., Perceptron tree, support vector tree, Markov tree, decision tree forest, random forest), Pandon model and system, artificial fusion, sensor fusion, image fusion, reinforcement learning, augmented reality, pattern recognition, automated planning, and the like.

The sensor 740 may include one or more sensors for sensing at least one of pieces of information in the electronic device 700, surrounding environment information around the electronic device 700, and user information. For example, the sensor 740 may include at least one of a proximity sensor, an illumination sensor, a touch sensor, an acceleration sensor, a magnetic sensor, and a gravity sensor (G-sensor), Gyroscope sensor, motion sensor, RGB sensor, infrared sensor (IR sensor), fingerprint scan sensor, ultrasonic sensor, optical sensor, microphones, battery gauges, environmental sensors (e.g. barometers, hygrometers, thermometers, radiation sensors, thermal sensors, gas sensors, etc.), chemical sensors (e.g. electronics Nose, healthcare sensor, biometric sensor, etc.). Meanwhile, the electronic device 700 disclosed in the present disclosure may use a combination of information sensed by at least two or more of these sensors.

The output unit 750 serves to generate output related to visual, auditory, or tactile, and may include at least one of a display, an audio output unit, a haptic module, or an optical output unit. The display may display (output) information processed by the electronic device 700. For example, the display may display execution screen information of an application program run by the electronic device 700, or User Interface (UI) or Graphic User Interface (GUI) information according to the execution screen information. The display may be layered or integrally formed with the touch sensor, thereby implementing a touch screen. The touch screen may serve as an input unit 720 that provides an input interface between the electronic device 700 and the user while providing an output interface between the electronic device 700 and the user.

The sound output unit may output audio data received from the communication transceiver 710 or stored in the memory 770, in a call signal reception, a call mode or a recording mode, a voice recognition mode, a broadcast reception mode, and the like. According to an embodiment, the sound output unit may output a voice signal representing a response to a user query. The sound output unit may include at least one of a receiver, a speaker, or a buzzer.

The haptic module may generate various tactile effects (e.g., vibrations) that may be perceived by the user. The haptic module may include, for example, a vibration motor or a piezoelectric element.

The optical output unit outputs a signal for notifying the occurrence of an event by using light from a light source of the electronic device 700. The event may include, for example, at least one of message reception, call signal reception, missed call, alarm, calendar notification, email reception, or information reception through an application.

The memory 770 may store data supporting various functions of the electronic device 700. The memory 770 may store multiple application programs (or applications) that are run by the electronic device 700, data for operating the electronic device 700, instructions, and data for operating the learning processor 730 (e.g., at least one algorithm information for machine learning, etc.).

According to an embodiment, the memory 770 may include a cache memory. The cache memory may store query-related information received from a server (e.g., a cloud server).

The processor 780 may perform data processing and/or computation for overall operations of the electronic device 700. The processor 780 may drive software (e.g., a program) to control at least one other component included in the electronic device 700. The processor 780 may determine or predict at least one executable operation of the electronic device on the basis of information determined (or generated) using data analysis and machine learning algorithm. To this end, the processor 780 may request, retrieve, receive, or utilize data of the learning processor 730, and control at least one other component included in the device 700 to execute an operation that is predicted or an operation that is determined to be desirable, among at least one executable operation of the electronic device.

The processor 780 may perform various functions for implementing intelligent emulation (i.e., a knowledge based system, an inference system, and a knowledge acquisition system). This may be applied to various types of systems (e.g., fuzzy logic systems), including adaptive systems, machine learning systems, artificial neural networks, and the like.

The processor 780 also may include a submodule that enables operations that are accompanied by voice and natural language voice processing, such as I/O processing modules, environmental condition modules, speech-to-text (STT) processing modules, natural language processing modules, workflow processing modules, and service processing modules. Each of these submodules may have access to one or more systems or data and models, or a subset or a superset thereof, in the electronic device 700. In addition, each of these submodules may provide various functions, including lexical indexes, user data, workflow models, service models, and automatic speech recognition (ASR) systems. In other embodiments, other aspects of processor 780 or electronic device 700 may be implemented with the above-described submodules, systems, or data and models.

In some embodiments, the processor 780 may be configured to detect requirements on the basis of a contextual condition expressed in user input or natural language input or a user's intention. The processor 280 may detect the requirement corresponding to the user's intention on the basis of data of the learning processor 730.

The processor 780 may actively derive and obtain information that is necessary for determining the requirements corresponding to the contextual condition or the user's intention. For example, the processor 780 analyzes historical data (or historical information), including historical input and output, pattern matching, unambiguous words, input intent, and the like, thereby actively deriving the information required to determine the requirement.

The processor 780 may determine a task flow for executing a function that responds to the requirements on the basis of the contextual condition or the user's intention.

The processor 780 may be configured to collect, detect, extract, detect, and/or receive signals or data to be used for data analysis and machine learning tasks through one or more sensing components in the electronic device 700 to collect information for processing and storage in the learning processor 730. The information collection may include sensing information via a sensor, extracting information stored in memory 770, or receiving information from another artificial intelligence device, entity, or external storage device via a communication means.

The processor 780 may collect and store history information of the electronic device 700. The processor 780 may use the stored history information and predictive modeling to determine the best match for executing a particular function.

The processor 780 may receive or detect surrounding environment information or other information through the sensor 740. The processor 780 may receive a broadcast signal and/or broadcast related information, a wireless signal, and wireless data through the communication transceiver 710. The processor 780 may receive image information (or a corresponding signal), audio information (or a corresponding signal), data, or user input information from the input unit 720.

The processor 780 collects information in real time, processes or classifies the information (e.g., knowledge graphs, command policies, personalization databases, conversation engines, etc.), and store the processed information in the memory 770 or the learning processor 730.

When the operation of the electronic device 700 is determined on the basis of data analysis and machine learning algorithms and techniques, the processor 780 may control components of the electronic device 700 to perform the determined operation. The processor 780 may control the terminal according to the control command to perform the determined operation.

When a specific operation is performed, the processor 780 analyzes historical information indicating execution of specific operation through data analysis and machine learning algorithms and techniques, and updates the previously learned information on the basis of the analyzed information.

Accordingly, the processor 780, together with the learning processor 730, may improve the accuracy of the future performance of data analysis and machine learning algorithms and techniques on the basis of the updated information.

The processor 780 processes signals, data, information, and the like, which are input or output through at least one other component included in the electronic device 700, or runs an application program stored in the memory 770, thereby providing or processing information or function appropriate to the user.

According to various embodiments, the processor 780 may receive query-related information from a server and store the received query-related information inside or outside the processor 780 (e.g., the memory 770). For example, the processor 780 may store (or cache) query-related information in a cache storage device and/or a disk cache. The query-related information includes at least one of at least one query, at least one response corresponding to the at least one query, or at least one additional information (e.g., reliability, environmental condition information) corresponding to the at least one query. According to an embodiment, the processor 780 may perform control so that the query-related information cached in the cache storage device and/or the disk cache is updated on the basis of the predefined event. The updating of the query-related information may include at least one of a step of deleting previously cached query-related information and storing new query-related information, a step of maintaining previously cached query-related information and further storing new query-related information, or a step of deleting at least some of the previously cached query-related information. The predefined event may include at least one of a destination setting event, a new zone (or area) entry event, a user request event, and a predefined time elapsing event.

According to various embodiments, the processor 780 may detect a user query on the basis of a voice signal input through the input unit 720, and provide a response to the detected user query. The processor 780 may provide a response using cached query-related information according to the sensed user query, or use at least one of a embedded assistant or a server assistant or cloud assistant to acquire and provide a response. The embedded assistant may be a program that obtains and provides a response to a user query by using components and/or data embedded in the electronic device 700. For example, the embedded assistant may be a program run by an IC chip mounted in a vehicle capable of autonomous driving. The server assistant may be a program that accesses a server (e.g., a cloud server) through a network to acquire and provide a response to a user query.

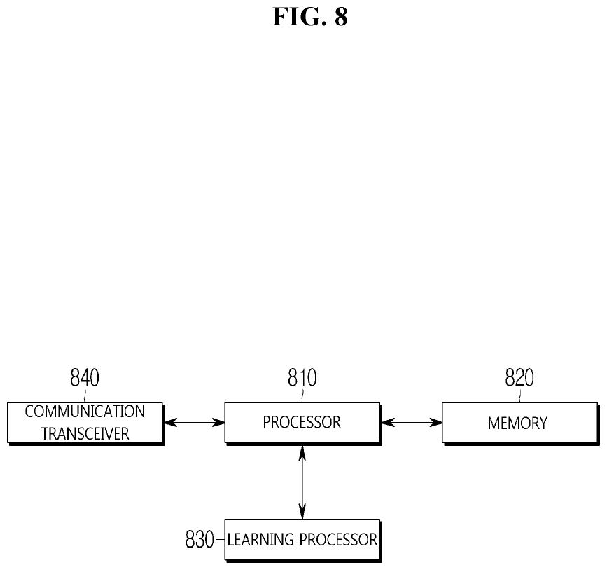

FIG. 8 is a block diagram illustrating a server according to various embodiments of the present disclosure. The server of FIG. 8 may be a server included in the 5G network of FIG. 1 and/or FIG. 2. The configuration of the server 800 illustrated in FIG. 8 is exemplary, and according to an exemplary embodiment, some of the components illustrated in FIG. 8 may be omitted or other components may be added. The server 800 of FIG. 8 may include a cloud server that provides a wireless network database function for the electronic device 700.

Referring to FIG. 8, the server 800 may include a processor 810, a memory 820, a learning processor 830, and a communication transceiver 840.

According to various embodiments, the processor 810 may perform data processing and/or computation for overall operations of the server 800. The processor 810 may receive a user query from at least one electronic device 700, search for the memory 820, and/or communicate with at least one other server to provide a response to the user query. According to an embodiment, the processor 810 may include the learning processor 830.

According to various embodiments, the learning processor 830 may be configured to receive, classify, store, and output information to be used in data mining, data analysis, intelligent decision making, and machine learning algorithms and/or techniques. The learning processor 830 may be implemented using the memory 870. The information stored in the learning processor 830 may be used by the processor 810 or one or more other controllers using any of a variety of different types of data analysis algorithms and machine learning algorithms. Examples of such algorithms include k-near neighbor systems, fuzzy logic (e.g., probability theory), neural networks, Boltzmann machines, vector quantization, pulse neural networks, support vector machines, maximum margin classifiers, hill climbing, inductive logic systems Bayesian network, Peretnet (e.g., finite state machine, Millie machine, Moore finite state machine), classifier trees (e.g., Perceptron tree, support vector tree, Markov tree, decision tree forest, random forest), Pandon model and system, artificial fusion, sensor fusion, image fusion, reinforcement learning, augmented reality, pattern recognition, automated planning, and the like.

According to an embodiment, the learning processor 730 may be configured to receive, classify, store, and output information to be used in data mining, data analysis, intelligent decision making, and machine learning algorithms and/or techniques. The learning processor 830 may include one or more memory units configured to store data, which is received, detected, generated, and predefined by the server 800; output, received, detected, generated, and predefined in other method; or output by an external device in communication with the server 800 in other method.

According to an embodiment of the present disclosure, the learning processor 830 may include an artificial intelligence module that may perform machine learning on input data using at least one artificial neural network.

According to an embodiment, the learning processor 830 may learn a model composed of an artificial neural network using the training data. Here, the learned artificial neural network may be referred to as a learning model. The learning model may be used to infer result values for new input data other than the training data, and the inferred values may be used as a basis for determining which operation is to be performed.

According to an embodiment, the learning processor 830 may learn the artificial neural network according to a machine learning algorithm on behalf of the electronic device 700, and directly store the learning model or transmit the same to the electronic device 700. The learning models may be implemented in hardware, software, or a combination of hardware and software. When some or all of the learning models are implemented in software, one or more instructions constituting the learning model may be stored in the memory 820. According to an embodiment, the processor 860 may infer a result value with respect to new input data by using a learning model trained by the learning processor 830 and generate a response or control command based on the inferred result value.

According to an embodiment, the learning processor 830 may collect and store a user query, response, and environment information from at least one electronic device 700. The learning processor 830 performs learning on the user query on the basis of the cumulatively stored information (or history information) using a model composed of an artificial neural network, and generates and/or updates query-related information on the basis of the learning result. According to an embodiment of the present disclosure, the learning processor 830 may generate and/or update general query-related information including information about a general query on the basis of the query frequency. The learning processor 830 may generate and/or update special query-related information detected under a specific environmental condition on the basis of the environment information. The processor 810 may provide the query-related information generated by the learning processor 830 to the at least one electronic device 700.

According to various embodiments, the memory 820 may include a cache memory. The cache memory may include at least one of a cache storage device or a disk cache. This is exemplary, and cache memories according to various embodiments of the present disclosure will not be limited thereto.

The memory 820 may store at least one of user queries, responses, and environment information collected from at least one electronic device 700. The response may be a response to a user query obtained by the electronic device 700 over the network. The environment information may include at least one of time information indicating a time point when the user query is detected by the electronic device 700, location information indicating the location of the electronic device 700 at the time point when the user query is detected, and information indicating network status at the time point when the user query is detected (for example, channel quality information), and user information (or user information corresponding to a user query) of the electronic device 700. According to an embodiment of the present disclosure, the environment information may further include information about a movement path of the electronic device 700. The memory 820 may store at least one of a general cache model for generating and/or updating general query-related information, or a special cache model for generating and/or updating special query-related information.

The communication transceiver 840 may support wireless communication between the server 800 and an external device (e.g., the electronic device 700 of FIG. 7). The communication transceiver 840 may be connected to a network through wireless or wired communication to make it possible to communicate with an external device. The wireless communication includes cellular communication using at least one of Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), or 5G communication, or short range communication using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless USB (Wireless Universal Serial Bus). The network may include at least one of, for example, a computer network (e.g., LAN or WAN), an Internet, or a telephone network which is a telecommunications network.

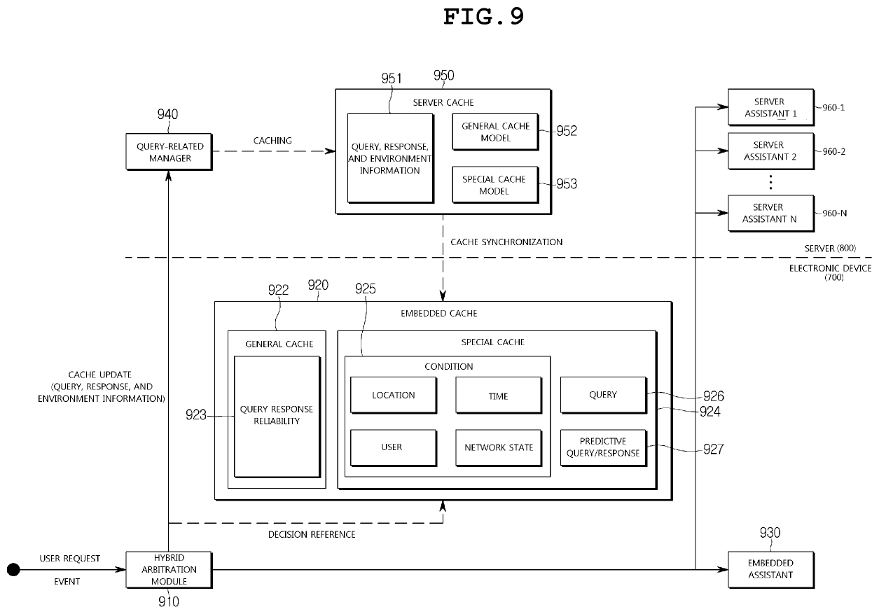

FIG. 9 is a conceptual block diagram illustrating a system for providing a response to a user query according to various embodiments of the present disclosure. The system shown in FIG. 9 may include an electronic device and a server. The electronic device of FIG. 9 may be the electronic device 700 of FIG. 7, and the server of FIG. 9 may be the server 800 of FIG. 8.

Referring to FIG. 9, the electronic device 700 includes a hybrid arbitration module 910, an embedded cache 920, and an embedded assistant 930; and the server 800 includes a query-related manager 940, a server cache 950, and multiple server assistants 960-1 through 960-N. The hybrid arbitration module 910 and the embedded assistant may be a software program executable by the processor 780 of the electronic device 700. The query-related manager 940 and the multiple server assistants 960-1 through 960-N may be software programs executable by the processor 810 of the server.

According to various embodiments, the hybrid arbitration module 910 may detect a user request and/or an event on the basis of a voice signal spoken by the user. The hybrid arbitration module 910 may detect a user query for requesting a response by analyzing the voice signal. Upon detecting the user query, the hybrid arbitration module 910 may determine whether the user query corresponds to a query for requesting a response using a network. According to an embodiment, when the user query corresponds to a query using a network query, the hybrid arbitration module 910 may retrieve a response to the user query by referring to the embedded cache 920. The hybrid arbitration module 910 may control the output unit 750 so that the response retrieved by referring to the embedded cache 920 is provided to the user.

According to an embodiment, when a response to a user query is not retrieved from the embedded cache 920, the hybrid arbitration module 910 may request the response to the user query with at least one of the multiple server assistants 960-1 to 960-N. The hybrid arbitration module 910 controls the output unit 750 so that when a response to a user query is received from at least one of the multiple server assistants 960-1 through 960-N, the received response is provided to the user. When the response to the user query is not received, the hybrid arbitration module 910 may control the output unit 750 so that a response acquisition failure guide message is provided to the user. The response acquisition failure guide message may include a response acquisition failure cause. The response acquisition failure cause may include, for example, information indicating that communication is not possible due to a weak network.

According to an embodiment, when the user query does not correspond to a query for requesting a response using a network query, the hybrid arbitration module 910 may make a request for a response to the user query to the embedded assistant 930. The hybrid arbitration module 910 may receive a response to the user query from the embedded assistant 930 and control the output unit 750 to provide the received response to the user.

According to an embodiment, the hybrid arbitration module 910 may collect environment information related to a user query using at least one component included in the electronic device 700. The collected environment information may include at least one of time information indicating a time point when the user query is detected, location information indicating the location of the electronic device 700 at the time point when the user query is detected, and information (for example, channel quality information) indicating network status at the time point when the user query is detected, and user information (or user information corresponding to a user query) of the electronic device 700. The hybrid arbitration module 910 may provide the server 800 with a user query, a response searched and/or obtained for the user query, and collected environment information.

According to an embodiment, the hybrid arbitration module 910 may determine a prediction query that is expected to be input from the user on the basis of the environment information of the electronic device 700 and the embedded cache 920. The hybrid arbitration module 910 may obtain a response to the prediction query from the server cache 950 or obtain a response to the prediction query by using at least one of the multiple server assistants 960-1 to 960-N. The hybrid arbitration module 910 may store the prediction query determined in accordance with the environment information of the electronic device 700 and the response thereto in the embedded cache 920.

The embedded cache 920 may be included inside and/or outside the processor 780 (e.g., the memory 770). The embedded cache 920 may include at least one of a cache storage device or a disk cache. According to an embodiment, the embedded cache 920 may receive and store (or cache) query-related information included in the server cache 950, and thus synchronized with the server cache 950. The embedded cache 920 may be synchronized with the server cache 950 under the control of the processor 780 and/or the hybrid arbitration module 910. According to an embodiment, the embedded cache 920 may receive and store at least some data cached in the server cache 950 under the control of the processor 780 and/or the hybrid arbitration module 910. For example, the embedded cache 920 may receive and store query-related information associated with at least one of a predefined region, a predefined area, or a predefined location from the server cache 950 under the control of the processor 780 and/or the hybrid arbitration module 910. For example, the embedded cache 920 may receive and store query information related to a current location of the electronic device 700 or a destination predefined by a user.

According to an embodiment, the embedded cache 920 may include a general cache 922 including information about a general query and a special cache 924 including information about a special query. The general query may be a query detected more than a predetermined number of times from at least one user, and the special query may be a query detected under a specific environmental condition. The general query and/or the special query may be selected and/or determined by the server 800. The general cache 922 may store queries (general queries), responses, and reliability 923 for queries and responses. The reliability may be determined on the basis of the consistency of the response to the query. The special cache 924 may store a query (special query) 926, a condition 925 related to the query, a prediction query, and a response 927. The environmental condition may include location, time, user, or network state information related to the special query. The prediction query and the response may be updated and/or deleted by the hybrid arbitration module 910.

According to various embodiments, the embedded assistant 930 may obtain a response to a user query by using components and/or data embedded in the electronic device 700. For example, when the user query is a query requiring vehicle interior temperature information, the embedded assistant 930 may collect vehicle interior temperature information from the sensor 740 and provide the collected vehicle interior temperature information as a response. This is illustrative, and embodiments of the present disclosure are not limited thereto.

According to various embodiments, the query-related manager 940 may be a program executable by the processor 810 of the server 800. The query-related manager 940 may store the query, response, and environment information received from the electronic device 700 in the server cache 950. The query, response, and environment information 951 received from the electronic device 700 may be stored to be associated with each other.

According to an embodiment, the query-related manager 940 generates and/or obtains general query-related information for each group and/or each individual by using the general cache model 952 on the basis of the queries and responses stored in the server cache 950. For example, the query-related manager 940 groups a plurality of users according to specified criteria (e.g., gender, region, household, company, and/or school), and determine queries detected (or occurred) more than a predetermined number of times within each group as a general query for each group. The query-related manager 940 may determine a query detected or generated more than the number of times specified by each user as a general query for each user. For example, when a first query for inquiring tourist attractions of the first region is detected from a plurality of users in the first group, the query-related manager 940 may determine the first query for inquiring tourist attractions of the first region as the general query of the first group. As another example, when the first query for inquiring tourist attractions of the first region is detected from the first user multiple times, the query-related manager 940 may determine the first query for inquiring the tourist attractions of the first region as the general query of the first individual user.

The query-related manager 940 may obtain a response stored in association with the general query from the server cache 950. The query-related manager 940 may determine the reliability on the basis of the consistency of the response(s) to the general query stored in association with the general query. The reliability may mean the reliability of the response to the general query. For example, the reliability may numerically indicate how reliable the response to the corresponding general query is. The reliability may be determined via learning using the general cache model 952. The query-related manager 940 may retrieve the responses stored in association with the first query in the server cache 950. When the searched responses are all the same as “Museum A”, the query-related manager 940 may determine “Museum A” as the response to the first query, and determine the reliability of the response to be about 100%. When the searched responses are “Museum A”, “Museum A”, “Museum A”, “Palace B”, and “Park C”, some of which are the same but some of which are different, the query-related manager 940 may determine, as the response, “Museum A” that is found many times, and herein the reliability of the determined response may be determined to be about 60%. Here, the reliability numerical values are exemplary, and the present disclosure will not be limited thereto. The query-related manager 940 may perform control so that the query-related information including the general query, response, and reliability of the group and/or individual is transmitted to the corresponding electronic device 700. According to an embodiment, the higher the consistency of the responses stored in association with the first query, the higher the reliability value (or level) of the response to the first query; and the lower the consistency of the responses stored in association with the first query, the lower the reliability value (or level) of the response to the first query. According to an embodiment, even when the first query is detected more than a predetermined number of times for each group and/or each individual, the query-related manager 940 may exclude the first query from the general query when all the corresponding responses are different from each other.

According to an embodiment, the query-related manager 940 may generate and/or obtain special query-related information using the special cache model 953 on the basis of the query stored in the server cache 950 and the environment information. For example, the query-related manager 940 may determine, as a special query, a query that is detected (or generated) more than a predetermined number of times in a specific environmental condition. For example, when a second query for inquiring a coffee shop nearby is detected more than a predetermined number of times in the morning time, the query-related manager 940 may determine the second query as a special query. The query-related manager 940 may perform control so that query-related information including a query determined as a special query and an environmental condition (e.g., location, time, user, and/or network status) for the query is generated and the generated query-related information control is transmitted to the electronic device 700.

According to various embodiments, each of the multiple server assistants 960-1 through 960-N may communicate with at least one other server via a network to obtain and provide a response to a user query. For example, when the user query is a query requesting today's weather information, at least one of the multiple server assistants 960-1 through 960-N communicates with a weather providing server via a network, thereby obtaining weather information and providing the acquired weather information to the electronic device 700. This is illustrative, and embodiments of the present disclosure are not limited thereto.

According to various embodiments, the electronic device 700 includes an input unit 720, an output unit 750, a memory 770, and at least one processor 730 and 780, wherein the at least one processor 730 and 780 performs control to receive query-related information from the server 800 through a network using a communication transceiver 710, store the received query-related information in the memory 770, detect a user query through the input unit 720, determine whether the user query is a query for requesting a response using a network, determine a response to the user query on the basis of the query-related information stored in the memory 770 when the user query is a query for requesting a response using the network, and output the determined response through the output unit 750, in which the query-related information may include at least one of at least one query, at least one response corresponding to the at least one query, or at least one additional information corresponding to the at least one query. According to an embodiment, a communication transceiver 710 is included in the electronic device 700 or connected to the electronic device 700 so that the communication transceiver may be communicated with the processors 730 and 780 or may perform at least one operation (e.g., a transmission/reception operation) under the control of the processors 730 and 780.

According to an embodiment, the at least one processor 730 and 780 determines whether a first query corresponding to the user query exists among the at least one query included in the query-related information stored in the memory 770 when the user query is a query for requesting a response using the network; determines the first response corresponding to the first query as a response to the user query when a first query corresponding to the user query exists; controls the communication transceiver 710 so that a signal for requesting a response is transmitted to the user query through the network to the server 800 when the first query corresponding to the user query does not exist.

According to an embodiment, the additional information may include the reliability of the at least one response corresponding to the at least one query, and the at least one processor 730 and 780 may determine whether the reliability for the first response corresponding to the first query satisfies a specified reliability condition; determine the first response as a response to the user query when the reliability for the first response satisfies the specified reliability condition; control the communication transceiver 710 so that a signal for requesting a response to the user query is transmitted to the server through a network when the reliability of the first response does not satisfy the specified condition.

According to an embodiment, the additional information includes an environmental condition related to the at least one query, in which the at least one processor 730 and 780 obtains environment information of the electronic device; determines at least one of the at least one query included in the query-related information as a prediction query on the basis of the obtained environment information and the environmental condition; controls the communication transceiver 710 so that a signal for requesting a response to the prediction query is transmitted to the server 800; receives a response to the prediction query from the server 800 via a network using the communication transceiver 710; and stores the prediction query and the response to the prediction query in the memory 770.

According to an embodiment, the at least one processor 730 and 780 determines whether the user query corresponds to the prediction query stored in the memory when the user query is a query for requesting a response using the network; obtains a response to the prediction query from the memory when the user query corresponds to the prediction query; and determines the response to the prediction query obtained from the memory as a response to the user query.

According to an embodiment, the environmental condition related to the at least one query may include at least one of location, time, user, or network state information related to the at least one query.

According to an embodiment, the at least one processor 730 and 780 deletes the prediction query and the response to the prediction query from the memory when a specified condition is satisfied, in which the specified condition may include a condition for at least one of time or location.

According to an embodiment, the at least one processor 730 or 780 detects a query-related information acquisition event on the basis of at least one of a current location, a destination, or a specified period of the electronic device, and controls the communication transceiver 710 so that a signal for requesting the query-related information is transmitted to the server through a network in response to detecting the query-related information acquisition event.

According to an embodiment, the at least one processor 730 or 780 may store the query-related information in a cache memory.

According to an embodiment, the at least one processor 730 or 780 performs control to obtain a response to the user query using at least one component included in the electronic device, and to output the obtained response through the output unit, when the user query is not a query for requesting a response using the network.

According to an embodiment, on the basis of the received query-related information, the at least one processor 730 and 780 determines whether the network condition of the first area corresponding to the expected movement path of the electronic device satisfies a specified condition; determines a query corresponding to the first region among the at least one query included in the received query-related information as a prediction query when a network state of the first region satisfies a specified condition; obtains a response to the prediction query in communication with the server via the network before the electronic device enters the first area; caches the prediction query and the response to the prediction query in the memory 770.

According to various embodiments, the server 800 includes a communication transceiver 840, a memory 820, and a processor 810. The processor 810 receives feedback information including at least one query from an electronic device 700 via a network using the communication transceiver 840 and then stores the same in the memory 820; generates query-related information to be provided to the electronic device on the basis of the information stored in the memory 820; and controls the communication transceiver 840 to transmit the generated query-related information to the electronic device 700 through a network, in which the query-related information may include at least one of at least one query, at least one response corresponding to the at least one query, or at least one additional information corresponding to the at least one query.

According to an embodiment, the feedback information further includes a response to the at least one query, in which the processor 810 is configured to generate the query-related information on the basis of at least one of the frequency of the at least one query or the consistency of the response to the at least one query.

According to an embodiment, the query-related information may further include the reliability of the at least one response corresponding to the at least one query, in which the processor 810 may be configured to determine the reliability on the basis of the consistency of the response to the at least one query.

According to an embodiment, the feedback information further includes environment information for the at least one query, and the processor 810 may be configured to generate the query-related information on the basis of the frequency for the at least one query and the environment information for the at least one query.

According to an embodiment of the present disclosure, the query-related information further includes an environmental condition related to the at least one query, and the processor 810 may be configured to determine the environmental condition on the basis of the environment information in which at least one query is detected more than a predetermined number of times.

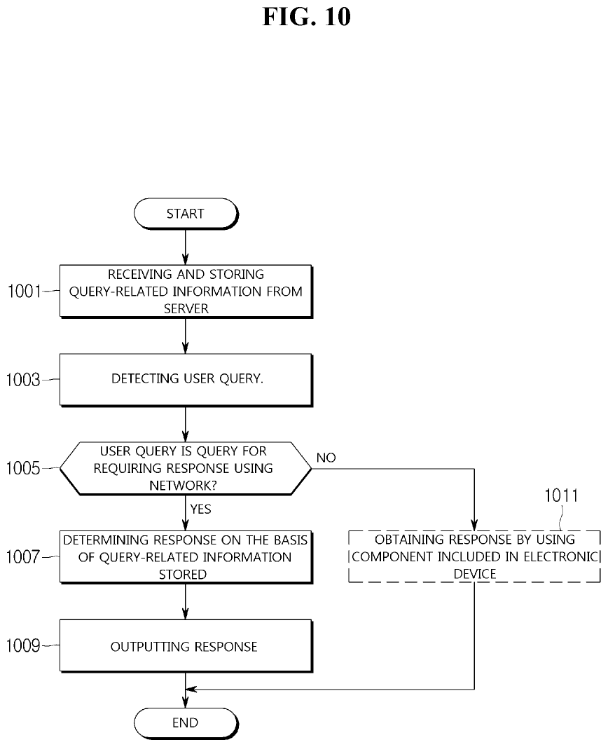

FIG. 10 is a flowchart illustrating providing a response to a user query in an electronic device according to various embodiments of the present disclosure. In the following embodiments, each operation may be performed sequentially, but are not necessarily performed sequentially. For example, the order of each operation may be changed, and at least two operations may be performed in parallel. Here, the electronic device may be the electronic device 700 of FIG. 7, and the server may be the server 800 of FIG. 8. An operation shown by a dotted line in FIG. 10 may be omitted according to an exemplary embodiment.

Referring to FIG. 10, in step 1001, the electronic device 700 may receive and store query-related information from the server 800. The query-related information may include at least one of at least one query, at least one response corresponding to at least one query, reliability of at least one response, and environmental condition information corresponding to at least one query. According to an embodiment, the processor 780 of the electronic device 700 receives the query-related information from the server 800 through the network using the communication transceiver 710, and caches the received query-related information in cache memory (e.g., embedded cache 920) internal and/or external to the processor 780. The received query-related information may include at least one of general query-related information or special query-related information. The general query-related information may be stored in the general cache 922 of the embedded cache 920, and the special query-related information may be stored in the special cache 924 of the embedded cache 920.

In step 1003, the electronic device 700 may detect a user query. According to an embodiment, the processor 780 of the electronic device 700 may detect a user query by analyzing a voice signal input through the input unit 720. For example, the processor 780 may convert a voice signal into text data and detect a user query for requesting a response on the basis of the converted text data.

In step 1005, the electronic device 700 may determine whether the user query is a query for requiring a response using a network. For example, the processor 780 of the electronic device 700 analyzes text data corresponding to a user query, to determine whether the query may be processed using the embedded assistant 930 or using the server assistants 960-1 to 960-N. For example, when the user query is a query for inquiring the vehicle interior temperature, the processor 780 may measure the vehicle interior temperature using the sensor 740 of the electronic device 700, and thus determine that the user query corresponds to a query that may be processed using the embedded assistant 930. When the user query is a query for inquiring today's weather, the processor 780 detects that an access to the weather server is required, and determines that the user query corresponds to a query that may be processed using the server assistants 960-1 to 960-N. When the user query is a query that may be processed using the embedded assistant 930, the processor 780 may determine that the query is not a query for requesting a response using the network. When the user query is a query that may be processed using the server assistants 960-1 to 960-N, the processor 780 may determine that the query is a query for requesting a response using a network.

When the user query is a query for requesting a response using the network, in step 1007, the electronic device 700 may determine a response on the basis of the query-related information stored in the embedded cache 920. According to an embodiment, when the user query is a query that requires a network connection to provide a response, or a query that may be processed using the server assistants 960-1 to 960-N, the processor 780 of the electronic device 700 may determine a response to the user query on the basis of the query-related information cached in the cache memory (i.e., embedded cache 920). For example, the processor 780 may retrieve a query corresponding to the user query from the query-related information cached in the embedded cache 920, and determine a response associated with the retrieved query as a response to the user query. For example, when the user query is a query for inquiring today's weather, the processor 780 may obtain information on today's weather on the basis of the query for requesting a response using a network or the query-related information cached in the cache memory 920. According to the present embodiment, even though a response should be received from the cloud assistant through a network connection, the response may be provided to the user using the response pre-stored in the embedded cache 920. Thus, even when the network is offline, the embedded assistant 930 may respond to a query that may not be processed. In addition, in the case of frequent queries based on characteristics of the user, the electronic device 700 provides an immediate response using the embedded cache 920 without performing communication through the network, thereby reducing the response time. In addition, in the case of the predicted query based on the characteristics of the user, the response is prepared in advance, thereby reducing the response time, and the response may be prepared in advance even when the network offline is predicted. Therefore, even when a user query for requesting a network connection is detected in the network offline state, the electronic device 700 may not only provide a response to the user query, but also reduce the response time.

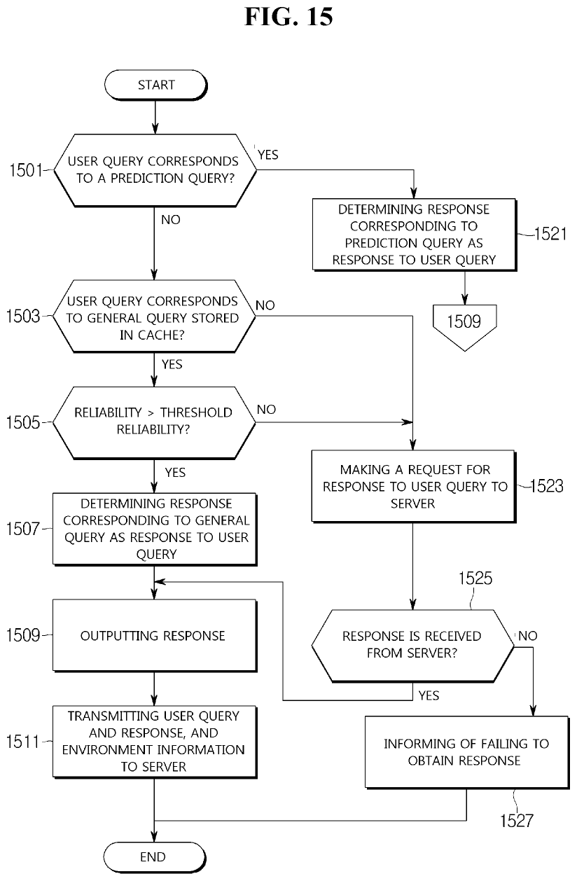

According to an embodiment, when the user query is a query for requesting a response using a network, but a response corresponding to the user query does not exist in the embedded cache 920, the electronic device 700 may obtain a response corresponding to the user query using the server assistants 960-1 to 960-N. The detailed operation thereof may be configured to include at least some steps (e.g., step 1501, step 1503, step 1523, step 1525, step 1527, and/or step 1509) of FIG. 15 described below.

In step 1009, the electronic device 700 may output a response to the user query. According to an embodiment, the processor 780 of the electronic device 700 may perform control so that a response determined on the basis of the stored query-related information is output through the output unit 750. For example, the electronic device 700 may output a response through a display and/or a sound output unit.

When the user query is not a query for requesting a response using a network, the electronic device 700 may obtain a response by using a component included in the electronic device in step 1011. According to an embodiment, when the user query is a query that does not require a network connection to provide a response, or a query that may be processed using the embedded assistant 930, the processor 780 of the electronic device 700 may determine a response to the user query through the embedded assistant 930. For example, the processor 780 may obtain and/or determine a response to a user query using components and/or data embedded in the electronic device 700 through the embedded assistant 930.

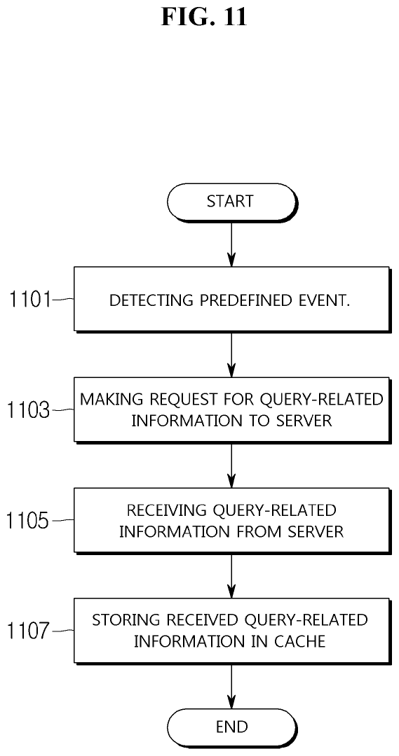

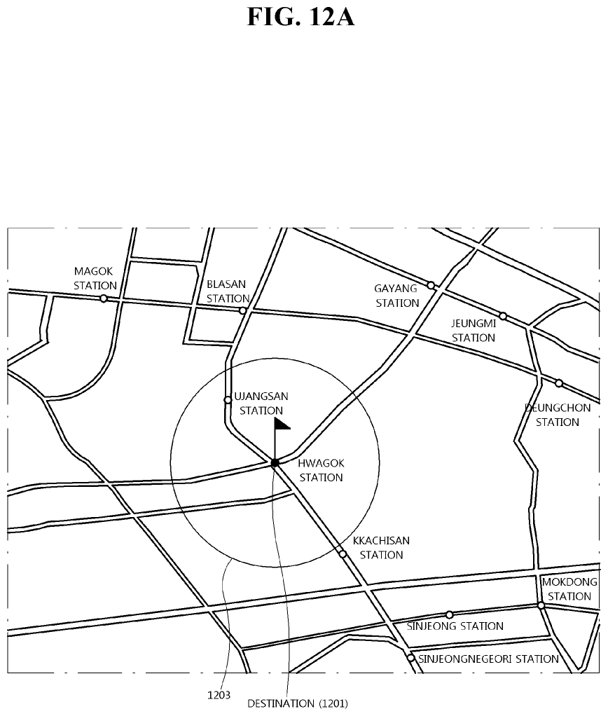

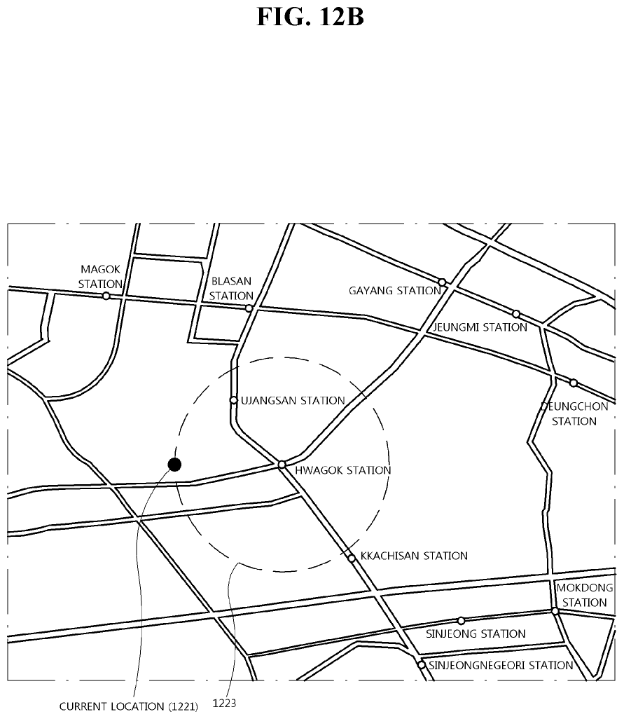

FIG. 11 is a flowchart illustrating caching query-related information in an electronic device according to various embodiments of the present disclosure. At least some operations of FIG. 11 may be detailed operations of step 1001 of FIG. 10. In the following embodiments, each operation may be performed sequentially, but are not necessarily sequentially performed. For example, the order of each operation may be changed, and at least two operations may be performed in parallel. Herein, the electronic device may be the electronic device 700 of FIG. 7, and the server may be the server 800 of FIG. 8. Hereinafter, at least some operations of FIG. 11 will be described with reference to FIGS. 12A and 12B. FIGS. 12A and 12B are exemplary diagrams illustrating caching query-related information in an electronic device according to various embodiments of the present disclosure.

Referring to FIG. 11, in step 1101, the electronic device 700 may detect a predefined event. According to an embodiment, the predefined event may include at least one of a destination setting event, a new region (or area) entry event, a user request event, or a predefined time elapsing event. For example, when the destination is set on the basis of a user input, the processor 780 of the electronic device 700 may determine that a predefined event for obtaining and/or updating query-related information has occurred. As another example, when it is detected that the processor 780 of the electronic device 700 enters a new area by the movement of the electronic device 700 or the movement of the vehicle including the electronic device 700, the processor 780 of the electronic 700 may determine that a predefined event for obtaining and/or updating query-related information has occurred. As another example, when a specified user input (e.g., a touch input, a button input, a voice input, or a gesture input) requesting acquisition and/or update of query-related information is detected, the processor 780 of the electronic device 700 may determine that a predefined event has occurred. As another example, when a specified time elapses from a time point when the query-related information is previously obtained from the server 800, the processor 780 of the electronic device 700 may determine that the predefined event has occurred.

In step 1103, the electronic device 700 may make a request for query-related information to the server 800. According to an embodiment, the processor 780 of the electronic device 700 may control the communication transceiver 710 to transmit a signal for requesting the query-related information to the server 800 in response to the detection of a predefined event. The signal for requesting query-related information may include at least one of destination information of the electronic device 700, information about an area which the electronic device 700 has entered, current location information of the electronic device 700, or user information (e.g., name, identification information, gender, generation, company, and/or school). For example, as shown in FIG. 12A, when the destination 1201 of the electronic device 700 is an office A located near Hwagok Station, the processor 780 of the electronic device 700 may transmit query-related information request signal including information indicating the location of Hwagok Station or the office A, to the server 800. As another example, as shown in FIG. 12B, when the current location of the electronic device 700 corresponds to a location of entry into Gangseo-gu, the processor 780 of the electronic device 700 may transmit query-related information request signal including Gangseo-gu or current location information, to the server 800.

In step 1105, the electronic device 700 may receive query-related information from the server 800. According to an embodiment, the query-related information received from the server 800 may be query-related information determined on the basis of information included in a signal for requesting the query-related information. For example, when the destination information of the electronic device 700 is included in a signal for requesting the query-related information, the electronic device 700 may receive the query-related information related to the destination from the server 800. For example, as shown in FIG. 12A, when the destination 1201 of the electronic device 700 is an office A located near Hwagok Station, the processor 780 of the electronic device 700 may receive the query-related information of a group for the first region 1203 including the office A corresponding to the destination 1201 from the server 800 in response to a query-related information request signal. As another example, when information about the entry area of the electronic device 700 is included in the signal for requesting the query-related information, the electronic device 700 may receive the query-related information related to the entry area from the server 800. For example, as shown in FIG. 12B, when the current location 1221 of the electronic device 700 corresponds to a location of entry into Gangseo-gu, the processor 780 of the electronic device 700 may receive the query-related information of a group for a Gangseo-gu region (or a part of Gangseo-gu) 1223 corresponding to the current location 1221 from the server 800, in response to a query-related information request signal. The query-related information of the group for the first region 1203, and/or the query-related information of the group for the Gangseo-gu region 1223 may include general query-related information (e.g., queries, responses, and reliability) generated frequently in the region. According to an embodiment, the query-related information received from the server 800 may include special query-related information determined on the basis of the user information included in a signal for requesting the query-related information. The special query-related information may include special query-related information (e.g., queries, and environmental conditions) frequently detected at a specific environmental condition (e.g., a specific time, and/or a specific location).

In step 1107, the electronic device 700 may store the received query-related information in a cache. According to an embodiment, the processor 780 of the electronic device 700 may store the received query-related information in a cache memory provided inside and/or outside the processor 780.

As described above, the electronic device 700 detects a predefined event and caches query-related information from a server, so that when a user query for requesting a response using a network is detected, the response may be provided using the query-related information cached in the electronic device 700 without communication with the server 800.

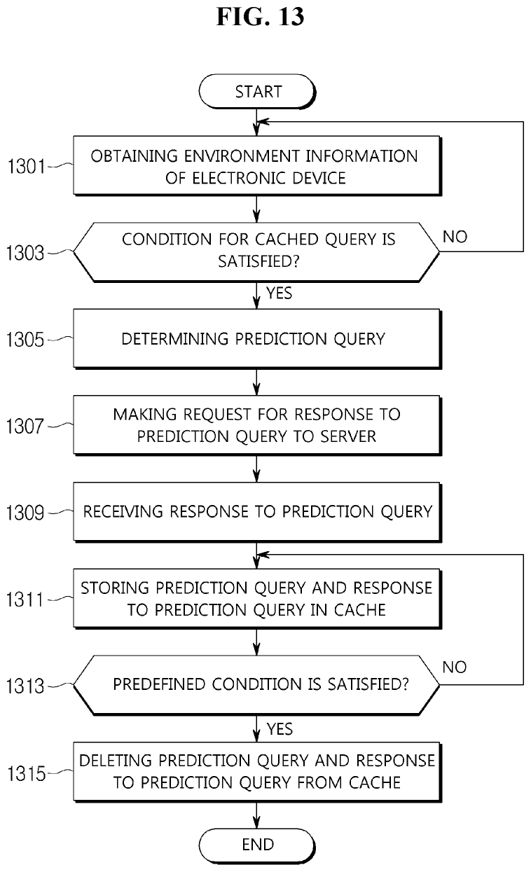

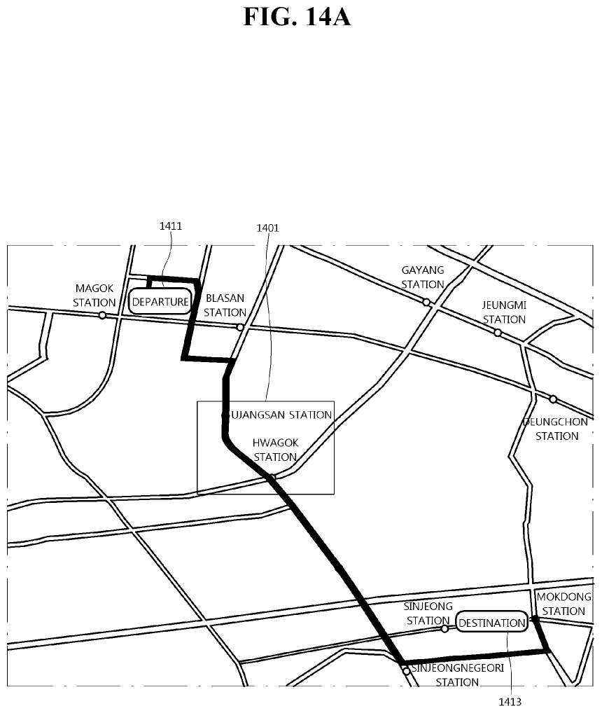

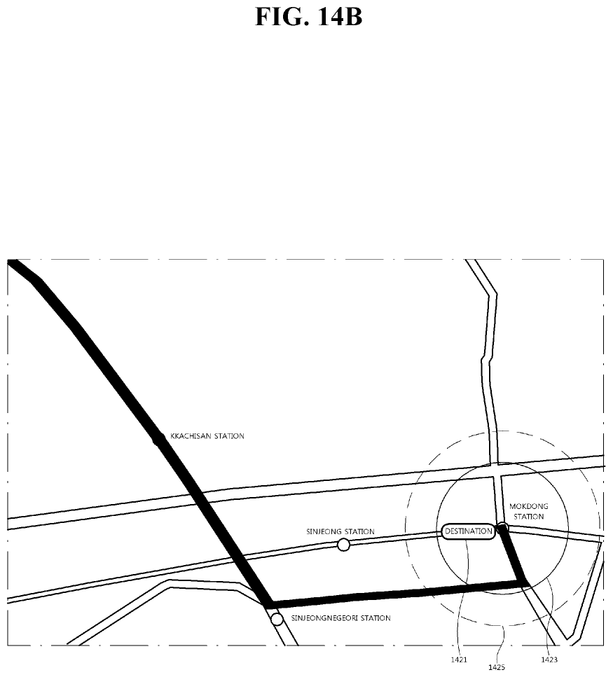

FIG. 13 is a flowchart illustrating caching prediction queries and responses in an electronic device according to various embodiments of the present disclosure. At least some operations of FIG. 13 may be operations performed between step 1001 and step 1003 of FIG. 10 or may be operations performed after step 1107 of FIG. 11. In the following embodiments, the operations may be performed sequentially, but are not necessarily performed sequentially. For example, the order of each operation may be changed, and at least two operations may be performed in parallel. Here, the electronic device may be the electronic device 700 of FIG. 7, and the server may be the server 800 of FIG. 8. Hereinafter, at least some operations of FIG. 13 will be described with reference to FIGS. 14A and 14B. FIGS. 14A and 14B are exemplary views illustrating caching prediction queries and responses in an electronic device according to various embodiments of the present disclosure.

Referring to FIG. 13, in step 1301, the electronic device 700 may obtain environment information of the electronic device. According to an embodiment of the present disclosure, the processor 780 of the electronic device 700 may obtain environment information indicating a surrounding environment of the electronic device 700 corresponding to a time point when a user query is detected. The environment information may include, for example, at least one of location information, network status information, movement path information, time information, or user information of the electronic device 700. The network status information may include, for example, channel quality information such as a received signal strength indicator (RSSI), a reference signal received power (RSRP), a signal to interference noise ratio (SINR), and/or a reference signal received quality (RSRQ).

In step 1303, the electronic device 700 may determine whether an environmental condition for the cached query is satisfied. According to an embodiment, the processor 780 of the electronic device 700 determines whether the environment information obtained in step 1301 satisfies the environmental condition 925 of the at least one special query 926 among the special queries cached in the special cache 924. For example, when the environment information obtained at the time point when the user query is detected is “location: point A” and “time: AM 07:10”, the processor 780 may determine whether there is a first special query that has an A special point or location information within a critical distance from the point A as an environmental condition or has AM 07:10 or time information within a threshold time from AM 07:10 as environment information, among special queries stored in the special cache 924. The processor 780 may determine that the environment information satisfies an environmental condition of the first special query when the first special query exists. As another example, when the environment information obtained at the time point when the user query is detected is “current location: A, destination: B, travel path: T path”, the processor 780 may determine whether there is a second special query whose network state information satisfies a specified network state condition while having, as an environmental condition, location information existing on or adjacent to T path that is a moving path between point A and point B, among the special queries stored in the special cache 924. The processor 780 may determine that the environment information satisfies an environmental condition of the second special query when the second special query exists.

In step 1305, the electronic device 700 may determine a prediction query on the basis of the satisfied environmental condition. According to an embodiment of the present disclosure, the processor 780 of the electronic device 700 may determine a special query having an environmental condition corresponding to environment information obtained from the special queries cached in the special cache 924 as a prediction query. For example, as shown in FIG. 14A, in the situation where the electronic device 700 moves from a location A 1411 to a location B 1413, the environmental condition of the second special query indicates “Location: region C 1401”, “Network State-Poor”, the processor 780 may determine, as a prediction query, a second special query that corresponds to the movement path (or expected movement path) of the electronic device and satisfies the specified network state condition. As another example, as shown in FIG. 14B, in the situation where the electronic device 700 is located within about 3 km (1425) from Mokdong Station 1421, which is the destination of arrival, the environmental condition of the first special query indicates “location: a region 1423 within a radius of 2 km from Mokdong station 1421, the processor 780 may determine, as a prediction query, a first special query having location information within a threshold distance (for example, about 4 km) from the current location of the electronic device as an environmental condition.

In step 1307, the electronic device 700 may make a request for a response to the prediction query to the server 800. For example, the processor 780 of the electronic device 700 may control the communication transceiver 710 to transmit, to the server 800, a signal requesting a response to the prediction query.

In step 1309, the electronic device 700 may receive a response to the prediction query from the server 800. For example, the processor 780 of the electronic device 700 may receive a signal including a response to a prediction query from the server 800 through the communication transceiver 710.

In step 1311, the electronic device 700 may store the prediction query and the response to the prediction query in a cache. According to an embodiment, the processor 780 of the electronic device 700 may cache the prediction query and response 927 in a special cache 924 of the embedded cache 920.

In step 1313, the electronic device 700 may determine whether a predefined condition is satisfied with respect to the prediction query. The specified condition in relation to the prediction query may include at least one of a condition in which a specified time interval elapses or a condition in which the electronic device 700 moves more than a specified threshold distance. For example, the processor 780 of the electronic device 700 may determine whether a predetermined time interval elapses from a point time when the prediction query and response are stored, or whether the electronic device 700 moves more than a predetermined threshold distance after the prediction query and response are stored. The predetermined time interval and/or the predetermined threshold distance may be determined on the basis of an environmental condition (e.g., a time condition, a location condition) related to the prediction query.

When the predetermined condition is satisfied, the electronic device 700 may delete the prediction query and the response to the prediction query from the cache in step 1315. For example, when a predetermined time interval elapses from a time point when the prediction query and response are stored, the processor 780 of the electronic device 700 may delete the prediction query and response 927 cached in the special cache 924. For example, when the electronic device 700 moves more than a predetermined threshold distance after the prediction query and response are stored, the processor 780 of the electronic device 700 may delete the prediction query and response 927 cached in a special cache 924.

As described above, the electronic device 700 predicts a user query that is expected to be input from the user by using the environment information, and obtains and caches a response thereto in advance, whereby it is possible to provide the response to the user query even in a situation where communication using the network is difficult. For example, as shown in FIG. 14A, the electronic device 700 may use the environment information to cache the prediction query and response before entering an area where network connection is impossible or a region C 1401 where the network channel quality is poor (or the signal reception strength from the network is lower than the threshold signal reception strength), it is possible to provide the response to the user query using the cached prediction query and response, even when the user query is detected in the state located in the region C 1401.

FIG. 15 is a flowchart illustrating providing a response to a user query for requesting a response using a network in an electronic device according to various embodiments of the present disclosure. At least some of the operations of FIG. 15 may be detailed operations of steps 1007 and 1009 of FIG. 10. In the following embodiments, the operations may be performed sequentially, but are not necessarily performed sequentially. For example, the order of each operation may be changed, and at least two operations may be performed in parallel. Here, the electronic device may be the electronic device 700 of FIG. 7, and the server may be the server 800 of FIG. 8.

Referring to FIG. 15, in step 1501, the electronic device 700 may determine whether a user query corresponds to a prediction query. The user query may include a user query for requesting a response using the network detected in step 1003 of FIG. 10. The processor 780 of the electronic device 700 may compare the user query with the prediction query cached in the special cache 924 of the embedded cache 920, to determine whether a prediction query corresponding to the user query exists.

When the user query corresponds to the prediction query, the electronic device 700 may determine a response corresponding to the prediction query as a response to the user query in step 1521. For example, the processor 780 of the electronic device 700 may determine a response to the prediction query cached in the special cache 924 as a response to the user query.

When the user query does not correspond to the prediction query, the electronic device 700 may determine whether the user query corresponds to a general query stored in the cache in step 1503. For example, the processor 780 of the electronic device 700 compares a user query with a general query cached in the general cache 922 of the embedded cache 920, to determine whether a general query corresponding to the user query exists.

When the user query corresponds to the general query stored in the cache, the electronic device 700 may determine whether the reliability of the response corresponding to the general query is greater than the threshold reliability in step 1505. According to an embodiment, the threshold reliability may be changed depending on whether the electronic device 700 is in a state capable of communication using a network. For example, when the electronic device 700 is in a state where communication using a network is possible, the threshold reliability may be set to a first reliability, and when the electronic device 700 is in a state where communication using the network is impossible, the threshold reliability may be set to a second reliability having a value lower than the first reliability. According to an embodiment, the threshold reliability may be a fixed value, regardless of whether the electronic device 700 is capable of communication using the network.

When the reliability of the response corresponding to the general query is more than the threshold reliability, the electronic device 700 may determine a response corresponding to the general query as a response to the user query in step 1507.

In step 1509, the electronic device 700 may output the determined response as a response to the user query. For example, the processor 780 of the electronic device 700 may perform control so that the response is output through the output unit 750.

When the reliability level for the response corresponding to the general query is less than or equal to the threshold reliability, or when the user query does not correspond to the general query stored in the cache, the electronic device 700 makes a request for a response to the user query to the server 800 in step 1523. For example, the processor 780 may make a request for a response to a user query to the server assistants 960-1 through 960-N. For example, when the user query does not correspond to the prediction query of the special cache 924 and does not correspond to the general query of the general cache 922, the processor 780 request a response to the user query to the server assistants 960-1 to 960-N.

In step 1525, the electronic device 700 may determine whether a response to the user query is received from the server 800. For example, the processor 780 of the electronic device 700 may determine whether a response to the user query is received from the server 800 within a predetermined time interval from a time point when the response to the user query is requested.

When the response to the user query is received from the server 800, the electronic device 700 may output the response received in step 1509 as a response to the user query.

In step 1511, the electronic device 700 may transmit a user query and response, and environment information to the server. For example, the processor 780 of the electronic device 700 may obtain environment information indicating the surrounding environment of the electronic device 700 and transmit the obtained environment information to the server 800 along with a user query and response. Here, the response may be a response obtained on the basis of the user query and the embedded cache 920, or a response received from the server 800. According to an embodiment, the user query and response, and environment information may be feedback information about the user query.

When a response to the user query is not received from the server 800, the electronic device 700 may inform that it has failed to obtain a response to the user query in step 1527. For example, the processor 780 of the electronic device 700 may perform control so that a response acquisition failure guide message for the user query is output through the output unit 750. The response acquisition failure guide message may include a response acquisition failure cause. The response acquisition failure cause may include, for example, information indicating that communication is not possible by a network weak field.

According to various embodiments of the present disclosure, since the electronic device 700 operates as described above with reference to FIG. 15, the response may be provided using the response pre-stored in the embedded cache 920, without assistance of server assistants 960-1 through 960-N via the network, upon detecting a user query for requesting a network response. Thus, even when the network is offline, the embedded assistant 930 may provide a response even for a query that cannot be processed. In addition, in the case of frequent queries based on the characteristics of the user, the electronic device 700 provides an immediate response using the embedded cache 920 without the help of the server assistants 960-1 to 960-N over the network, thereby reducing the response time. In addition, the response is prepared in advance in the case of the query predicted based on the characteristics of the user, thereby reducing the response time, and the response may be prepared in advance even when the network offline is predicted. Therefore, even when a user query for requesting a network connection is detected in the network offline state, the electronic device 700 may not only provide a response to the user query, but also reduce the response time.

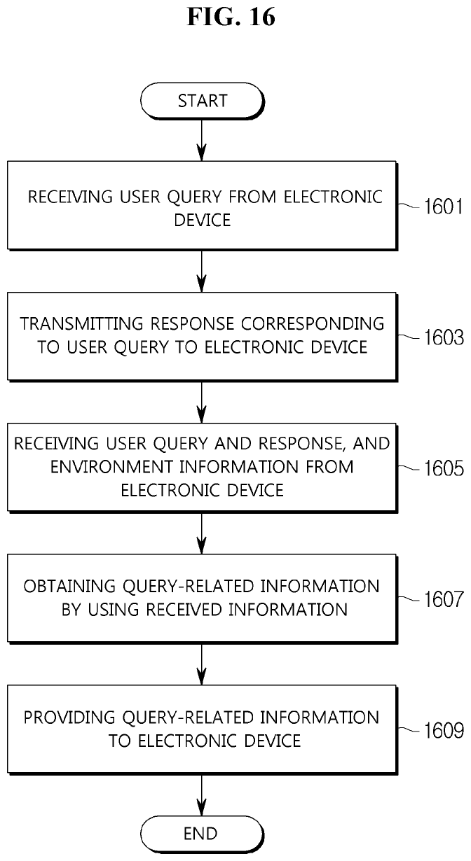

FIG. 16 is a flowchart illustrating providing query-related information in a server according to various embodiments of the present disclosure. In the following embodiments, the operations may be performed sequentially, but are not necessarily performed sequentially. For example, the order of each operation may be changed, and at least two operations may be performed in parallel. Here, the electronic device may be the electronic device 700 of FIG. 7, and the server may be the server 800 of FIG. 8.

Referring to FIG. 16, the server 800 may receive a user query from the electronic device 700 in step 1601. For example, the processor 810 of the server 800 may receive a signal for requesting a response to a user query from the electronic device 700 through the communication transceiver 840.

In step 1603, the server 800 may transmit a response corresponding to the user query to the electronic device. The processor 810 of the server 800 may communicate with at least one other server through a network to obtain and provide a response to a user query. For example, when the user query is a query for requesting today's weather information, the processor 810 may communicate with a weather providing server through a network using a server assistant, thereby obtaining weather information and providing the obtained weather information to the electronic device 700. This is illustrative, and embodiments of the present disclosure are not limited thereto.

In step 1605, the server 800 may receive a user query and response, and environment information from the electronic device 700. The environment information may be information representing surrounding environment of the electronic device 700 associated with the user query and response. According to an embodiment, the user query and response, and environment information may be feedback information about the user query.

In step 1607, the server 800 may obtain query-related information by using the received information. The processor 810 of the server 800 stores the received information in the server cache 950, and performs learning about the general cache model 952 and/or the special cache model 953 on the basis of the stored information, thereby obtaining query-related information including at least one of general query-related information or special query-related information. The general query-related information may include at least one of query-related information about a group or query-related information about an individual.

In step 1609, the server 800 may provide query-related information to the electronic device 700. According to an embodiment, when the query-related information about the electronic device 700 is updated, the processor 810 of the server 800 may transmit the updated query-related information to the electronic device 700 without a request of the electronic device 700. According to an embodiment, the processor 810 of the server 800 may transmit the query-related information to the electronic device 700 according to a request of the query-related information of the electronic device 700. For example, the processor 810 may receive, from the electronic device 700, a query-related information request signal including destination information, entry area information, current location information, or user information, and select the query-related information to be transmitted to the electronic device 700 from among the query-related information cached in the server cache 950, on the basis of the information included in the received query-related information request signal. The processor 810 may control the communication transceiver 840 so that the selected query-related information is transmitted to the electronic device 700.

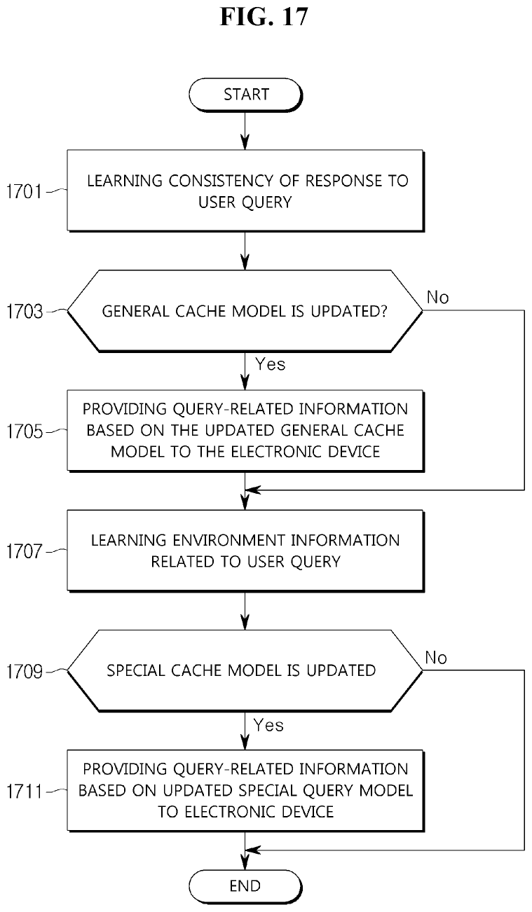

FIG. 17 is a flowchart illustrating query-related information learned in a server according to various embodiments of the present disclosure. At least some of the operations of FIG. 17 may be detailed operations of step 1607 of FIG. 16. In the following embodiments, the operations may be performed sequentially, but are not necessarily performed sequentially. For example, the order of each operation may be changed, and at least two operations may be performed in parallel. Here, the electronic device may be the electronic device 700 of FIG. 7, and the server may be the server 800 of FIG. 8.

Referring to FIG. 17, in step 1701, the server 800 may learn the frequency of a user query and the consistency of a response. According to an embodiment, the processor 810 of the server 800 may perform learning about a general cache model on the basis of multiple user queries and responses stored in the server cache 950. For example, the processor 810 determines a general query for a group and/or individual on the basis of the occurrence frequency of each user query and the information stored in the server cache 950, and determine the reliability of the response on the basis of the consistency of the response to the user query determined as a general query. The learning results for the general cache model may include general queries, responses, and reliability.

In step 1703, the server 800 may determine whether the general cache model is updated on the basis of the learning result. The processor 810 of the server 800 may determine whether general query-related information is updated on the basis of the learning result. For example, the processor 810 may determine whether at least one of the general query, the response, or the reliability has been updated through learning based on the frequency of the user query and the consistency of the response. For example, it is possible to determine whether new general queries, responses, and reliability have been added, or whether the reliability of existing general queries and responses has changed.

When the general cache model is updated on the basis of the learning result, the server 800 may provide query-related information based on the updated general cache model to the electronic device 700 in step 1705. For example, the processor 810 of the server 800 controls the communication transceiver 710 to transmit the updated general query-related information to the electronic device 700, when at least one of the general query, response, or reliability is updated through learning based on the frequency of the user query and the consistency of the response.

In step 1707, the server 800 may learn environment information related to a user query. According to an embodiment, the processor 810 of the server 800 may perform learning on a special cache model on the basis of a plurality of user queries stored in the server cache 950 and environment information related thereto. For example, the processor 810 may determine, as a special query, a query that occurs more than a predetermined number of times in a specific environmental condition on the basis of the information stored in the server cache 950.

In step 1709, the server 800 may determine whether the special cache model is updated on the basis of the learning result. The processor 810 of the server 800 may determine whether the special query-related information is updated on the basis of the learning result. For example, the processor 810 may determine whether at least one of the special query or the environmental condition for the special query is updated through learning based on the frequency of the user query and the environment information. For example, it is possible to determine whether new special queries and environmental conditions have been added, or environmental conditions for existing special queries have changed.

When the special cache model is updated on the basis of the learning result, the server 800 may provide query-related information based on the updated special cache model to the electronic device 700 in step 1711. For example, the processor 810 of the server 800 may control the communication transceiver 710 to transmit the updated special query-related information to the electronic device 700, when at least one of the special query or the environmental condition for the special query is updated through learning based on the frequency of the user query and the environment information.

In the above description, although the electronic device is described as being included in the vehicle, the electronic device according to various embodiments disclosed in the present disclosure is not limited to the electronic device included in the vehicle, and may be various types of electronic devices. For example, the electronic device may include a portable mobile communication device (e.g., a smartphone), a computer device, a portable multimedia device, a portable medical device, a camera, a wearable device, or a home appliance device. This is an example, and the electronic device according to various embodiments of the present disclosure is not limited to the above-described devices.

The electronic device according to various embodiments of the present disclosure previously obtains query-related information from the server and caches the same in advance, and then provides the response to the user query on the basis of the cached query-related information, thereby providing the response to the user query in a short time using a network.

The electronic device according to various embodiments of the present disclosure may previously obtain query-related information from the server and cache the same, thereby providing the response to the user query for requesting a response using the network in a situation where network access is impossible.

1. An electronic device, comprising:
an input unit;
an output unit;
a memory; and
at least one processor, wherein the at least one processor is configured to:
receive query-related information from a server over a network,
store the received query-related information in the memory,
detect a user query through the input unit,
determine whether the user query is a query for requesting a response using the network,
determine a response to the user query on the basis of the query-related information stored in the memory, when the user query is the query for requesting the response using the network, and
control the output unit to output the determined response, wherein the query-related information comprises at least one of at least one query, at least one response corresponding to the at least one query, or at least one additional information corresponding to the at least one query.

2. The electronic device of claim 1, wherein the at least one processor is further configured to:
determine whether a first query corresponding to the user query exists among at least one query included in the query-related information stored in the memory when the user query is the query for requesting the response using the network,
determine a first response corresponding to the first query as the response to the user query, when the first query corresponding to the user query exists, and
control a communication transceiver to transmit a signal for requesting the response to the user query to the server, when the first query corresponding to the user query does not exist.

3. The electronic device of claim 2, wherein the additional information comprises a reliability of the at least one response to the at least one query; and
wherein the at least one processor is further configured to:
determine whether a reliability of the first response corresponding to the first query satisfies a predetermined reliability condition,
determine the first response as the response to the user query when the reliability for the first response satisfies the predetermined reliability condition, and
control the communication transceiver to transmit the signal for requesting the response to the user query when the reliability of the first response does not satisfy the predetermined reliability condition.

4. The device of claim 1, wherein the additional information comprises an environmental condition related to the at least one query; and
wherein the at least one processor is further configured to:
obtain environment information of the electronic device,
determine at least one of at least one query included in the query-related information as a prediction query on the basis of the obtained environment information and the environmental condition,
control a communication transceiver to transmit a signal for requesting a response to the prediction query to the server,
receive the response to the prediction query from the server, and
store the prediction query and the received response to the prediction query in the memory.

5. The electronic device of claim 4, wherein the at least one processor is further configured to:
determine whether the user query corresponds to the prediction query stored in the memory when the user query is a query for requesting a response using the network,
obtain the response to the prediction query from the memory when the user query corresponds to the prediction query, and
determine the obtained response to the prediction query as the response to the user query.

6. The electronic device of claim 4, wherein the environmental condition related to the at least one query comprises at least one of location, time, user, or network state information related to the at least one query.

7. The electronic device of claim 4, wherein the at least one processor is further configured to delete the prediction query and the response to the prediction query from the memory when a predetermined condition is satisfied; and
wherein the specified condition comprises a condition for at least one of a time or a location.

8. The electronic device of claim 1, wherein the at least one processor is further configured to:
detect a query-related information acquisition event on the basis of at least one of a current location, a destination, or a predetermined period of the electronic device, and
control a communication transceiver to transmit a signal for requesting the query-related information to the server in response to detecting the query-related information acquisition event.

9. The electronic device of claim 1, wherein the at least one processor is further configured to store the query-related information in a cache memory.

10. The electronic device of claim 1, wherein the at least one processor is further configured to obtain the response to the user query using at least one component included in the electronic device when the user query is not a query for requesting a response using the network, and
control the output unit to output the obtained response.

11. The electronic device of claim 1, wherein the at least one processor is further configured to:
determine whether a network state of a first area corresponding to an expected movement path of the electronic device satisfies a predetermined condition, on the basis of the received query-related information,
determine, as a prediction query, a query corresponding to the first area among the at least one query included in the received query-related information, when the network state of the first area satisfies the predetermined condition;
obtain a response to the prediction query in communication with the server through the network before the electronic device enters the first area; and
cache the prediction query and the response to the prediction query in the memory.

12. The electronic device of claim 1, wherein the electronic device is included in an autonomous vehicle; and
wherein the network comprises any one of LTE, LTE-A, 5G, or V2X.

13. A server, comprising:
a communication transceiver;
a memory; and
a processor, wherein the processor is configured to:
receive feedback information including at least one query from an electronic device through the communication transceiver,
store the feedback information in the memory,
generate query-related information to be provided to the electronic device on the basis of the information stored in the memory, and
control the communication transceiver to transmit the generated query-related information to the electronic device; and
wherein the query-related information comprises at least one of at least one query, at least one response corresponding to the at least one query, or at least one additional information corresponding to the at least one query.

14. The server of claim 13, wherein the feedback information further comprises a response to the at least one query; and
wherein the processor is further configured to generate the query-related information on the basis of at least one of a frequency of the at least one query or a consistency of the response to the at least one query.

15. The server of claim 14, wherein the query-related information further comprises a reliability of the at least one response corresponding to the at least one query; and
wherein the processor is further configured to determine the reliability on the basis of the consistency of the response to the at least one query.

16. The server of claim 13, wherein the feedback information further comprises environment information related to the at least one query; and
wherein the processor is further configured to generate the query-related information on the basis of a frequency for the at least one query and the environment information related to the at least one query.

17. The server of claim 16, wherein the query-related information further comprises an environmental condition related to the at least one query; and
wherein the processor is further configured to determine the environmental condition on the basis of environment information in which the at least one query is detected more than a predetermined number of times.

18. A method of providing a response to an electronic device, the method comprising:
receiving query-related information from a server via a communication transceiver;
caching the received query-related information;
detecting a user query through an input unit;
determining whether the user query is a query for requesting a response using a network;
determining a response to the user query on the basis of the cached query-related information when the user query is the query for requesting a response using the network; and
outputting the determined response through an output unit, wherein the query-related information comprises at least one of at least one query, at least one response corresponding to the at least one query, or at least one additional information corresponding to the at least one query.

19. The method of claim 18, wherein the determining of the response to the user query on the basis of the cached query-related information comprises:
determining whether a first query corresponding to the user query exists among the at least one query included in the cached query-related information;
determining a first response corresponding to the first query as the response to the user query when a first query corresponding to the user query exists; and
transmitting a signal for requesting the response to the user query to the server through the communication transceiver when the first query corresponding to the user query does not exist.

20. The method of claim 18, wherein the additional information comprises an environmental condition related to the at least one query, and the method further comprising:
obtaining environment information of the electronic device;
determining at least one of the at least one query included in the query-related information as a prediction query on the basis of the obtained environment information and the environmental condition;
transmitting a signal for requesting a response to the prediction query to the server through the communication transceiver;
receiving the response to the prediction query from the server via the communication transceiver; and
caching the prediction query and the response to the prediction query.

21. The method of claim 20, wherein the determining of the response to the user query on the basis of the cached query-related information includes:
determining whether the user query corresponds to the cached prediction query when the user query is the query for requesting the response using the network; and
determining the response to the prediction query as the response to the user query when the user query corresponds to the prediction query.
